(19) United States
(12) Patent Application Publication
(10) Pub. No.: US 2016/0078235 A1
(43) Pub. Date: Mar. 17, 2016

(54) DEVICE AND MANAGEMENT MODULE

(71) Applicants: Naoya MORITA, Kanagawa (JP); Hitoshi NAMIKI, Kanagawa (JP)

(72) Inventors: Naoya MORITA, Kanagawa (JP); Hitoshi NAMIKI, Kanagawa (JP)

(73) Assignee: RICOH COMPANY, LTD., Tokyo (JP)

(21) Appl. No.: 14/844,242

(22) Filed: Sep. 3, 2015

(30) Foreign Application Priority Data
Sep. 12, 2014 (JP) 2014-186453

(51) Int. Cl. G06F 21/60; G06F 21/31

(52) U.S. Cl. CPC G06F 21/604; G06F 21/31

(57) ABSTRACT

A device holding control target data includes a management unit configured to manage the present life cycle state of the device; an authentication unit configured to authenticate a user and indicate a role of the user; a control unit configured to acquire a present life cycle state when a request to access the control target data is received, authenticate the user and acquire the role, acquire access possibility information based on the present life cycle state and the role, and control the access based on the access possibility information; and a prohibiting unit configured to compare a position/time allowed in operation plan information with a present position/time, and prohibit the access when these information items do not match, based on the operation plan information in which life cycle states are associated with positions and times that are allowed for state transitions of the life cycle states.

### BACKGROUND OF THE INVENTION

1. Field of the Invention

The present invention relates to a device and a management module.

2. Description of the Related Art

In the technical field of embedded devices, important electronic information is stored in the modules of the embedded device, and high-level security for protecting the electronic information is becoming necessary. Here, an embedded device is formed by embedding a module in a device such as a home electric appliance, a machine, etc., in order to realize a particular function.

Furthermore, in an embedded device, there is demand to maintain the safety of the electronic information throughout the life cycle, including the respective stages (states) such as manufacturing and disposing, that is, to consistently maintain the safety of the electronic information in the device. For example, when the main user is changed according to the life cycle, it is highly necessary to secure the safety of the electronic information.

The embedded device has a risk in that the main user may change according to the life cycle, and safety needs to be secured in these cases. Accordingly, there is known a life cycle management system for providing device operations and access control functions based on the life cycle state with respect to the entire device. For example, for the purpose of appropriately protecting user data stored inside a memory when repairing or disposing an IC card product, there is disclosed a configuration of an access device that stores confidential information at each of a plurality of stages in a life cycle from manufacturing to disposing. Every time the stage transits to another stage, a predetermined procedure is taken, and the information can be read and written according to the access authority at the stage after transition (see, for example, Patent Document 1).

However, in the conventional life cycle management system of an embedded device, at the time when transition is made to another stage in the life cycle, a malicious user may transit to a different stage from the stage to which the transition is supposed to be made, a user access authority that is not supposed to be given may be given to the malicious user, and data that is not supposed to be accessed may be accessed by the malicious user. For example, there has been a risk that when a stage shift request command is issued according to impersonation, an unauthorized access authority may be given.

Patent Document 1: Japanese Laid-Open Patent Publication No. 2007-4624

### SUMMARY OF THE INVENTION

The present invention provides a device and a management module, in which one or more of the above-described disadvantages are eliminated.

According to an aspect of the present invention, there is provided a device holding control target data inside the device, the device including a state management unit configured to manage a life cycle state that the device is presently in; a user authentication unit configured to receive authentication data, authenticate a user, and give a response indicating a role of the user; an access control unit configured to acquire a present life cycle state from the state management unit when an access request to access the control target data is received, authenticate the user by the user authentication unit and acquire the role of the authenticated user, acquire access possibility information based on the present life cycle state and the role of the user who has made the access request, the access possibility information being acquired from a state access control policy associated with the control target data, and control access to the control target data based on the access possibility information; and an access prohibiting unit configured to perform a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

According to an aspect of the present invention, there is provided a management module installed in a device holding control target data inside the device, the management module including a state management unit configured to manage a life cycle state that the device is presently in; a user authentication unit configured to receive authentication data, authenticate a user, and give a response indicating a role of the user; an access control unit configured to acquire a present life cycle state from the state management unit when an access request to access the control target data is received, authenticate the user by the user authentication unit and acquire the role of the authenticated user, acquire access possibility information based on the present life cycle state and the role of the user who has made the access request, the access possibility information being acquired from a state access control policy associated with the control target data, and control access to the control target data based on the access possibility information; and an access prohibiting unit configured to perform a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

According to an aspect of the present invention, there is provided a non-transitory computer-readable recording medium storing a program that causes a computer that constitutes a management module installed in a device holding control target data inside the device, to execute a process including managing a life cycle state that the device is presently in; receiving authentication data, authenticating a user, and giving a response indicating a role of the user; acquiring a present life cycle state managed at the managing when an access request to access the control target data is received; authenticating the user and acquiring the role of the authenticated user; acquiring access possibility information based on the present life cycle state and the role of the user who has made the access request, the access possibility information being acquired from a state access control policy associated with the control target data; controlling access to the control target data based on the access possibility information; and performing a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a life cycle;

FIG. 2 illustrates an embedded device according to an embodiment;

FIG. 3 is a hardware configuration diagram of a life cycle state management module according to an embodiment;

FIG. 4 is a hardware configuration diagram of a control module according to an embodiment;

FIG. 5 is a functional block diagram of a life cycle state management module according to an embodiment;

FIG. 6 a functional block diagram of a control module according to an embodiment;

FIG. 7 illustrates a process where the life cycle state is changed;

FIGS. 8A through 8F illustrate examples of the state access control policies;

FIG. 9 is a flowchart of an access process to control target data;

FIG. 10 illustrates a process of changing the life cycle state;

FIG. 11 illustrates an example of operation plan information held by an authentication station;

FIG. 12 illustrates a configuration example of a position management device;

FIG. 13 illustrates an example of position registration information held by a position registration information storage unit of the position management device;

FIG. 14 illustrates a configuration example of a time management device;

FIG. 15 illustrates an example of calendar information held by the calendar information storage unit of the time management device;

FIG. 16 is a flowchart of a process example of regular control by the authentication device using the operation plan information;

FIG. 17 is a flowchart of a process example of a case where the authentication device receives unauthorized access information from the position management device or the time management device;

FIG. 18 is a flowchart of a process example of regular control by the position management device;

FIG. 19 illustrates an example of communication with surrounding elements performed in regular control by the position management device;

FIG. 20 is a sequence diagram of a process example of regular control by the position management device;

FIG. 21 is a flowchart of a process example of regular control by the time management device;

FIG. 22 is a flowchart of a process example of a case where the authentication device receives a query about the time from the time management device;

FIG. 23 is a flowchart of a process example of a case where the time management device receives a query from the authentication device;

FIG. 24 is a flowchart of a process example of case where the position management device receives a query from the authentication device;

FIGS. 25A and 25B illustrate specific examples of cases where control is not implemented based on the operation plan information; and

FIGS. 26A and 26B illustrate specific examples of cases where control is implemented based on the operation plan information.

### DETAILED DESCRIPTION OF THE PREFERRED EMBODIMENTS

A description is given, with reference to the accompanying drawings, of embodiments of the present invention.

### Embodiment

### Life Cycle

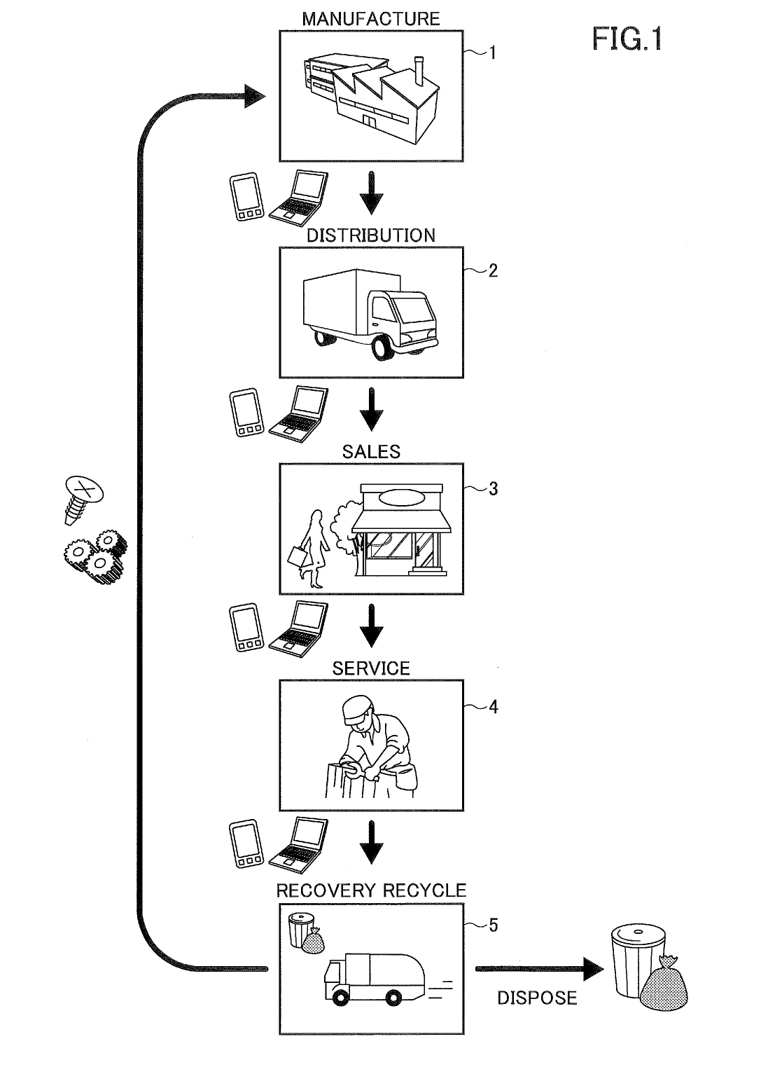

FIG. 1 illustrates an example of a life cycle of an embedded device. The life cycle states of an embedded device do not only include the process where the user simply uses the embedded device, but also include a manufacture stage 1 of manufacturing the embedded device at the factory, a distribution stage 2 of conveying the embedded device with transportation means such as a truck for selling the embedded device, and a sales stage 3 of selling the embedded device at an outlet store. Furthermore, the life cycle states of the embedded device include a service stage 4 of providing a service such as repairing the embedded device when the embedded device breaks down while being used by the user, and a recovery recycle stage 5 of recovering and recycling the embedded device from the viewpoint of environmental protection. Depending on the embedded device, there may be a dispose stage of disposing the embedded device in addition to or instead of the recovery recycle stage.

The life cycle illustrated in FIG. 1 may differ according to the delivery destination such as the country and area; however, in the present embodiment, as one example, the operations of the embedded device throughout these stages are collectively referred to as a life cycle. For example, control is implemented such that the life cycle is operated through a proper route (through proper stages) and it is proven that the life cycle is operated properly, in order to reliably recover and recycle the embedded device and to prevent the embedded device from being wrongfully used, from the viewpoint of environmental protection.

### <Embedded Device>

A description is given of an embedded device (hereinafter, “device”) such as a vehicle provided with a life cycle state management function, as an example of a device in which a life cycle state management function is installed. That is, an example of a device is an embedded device.

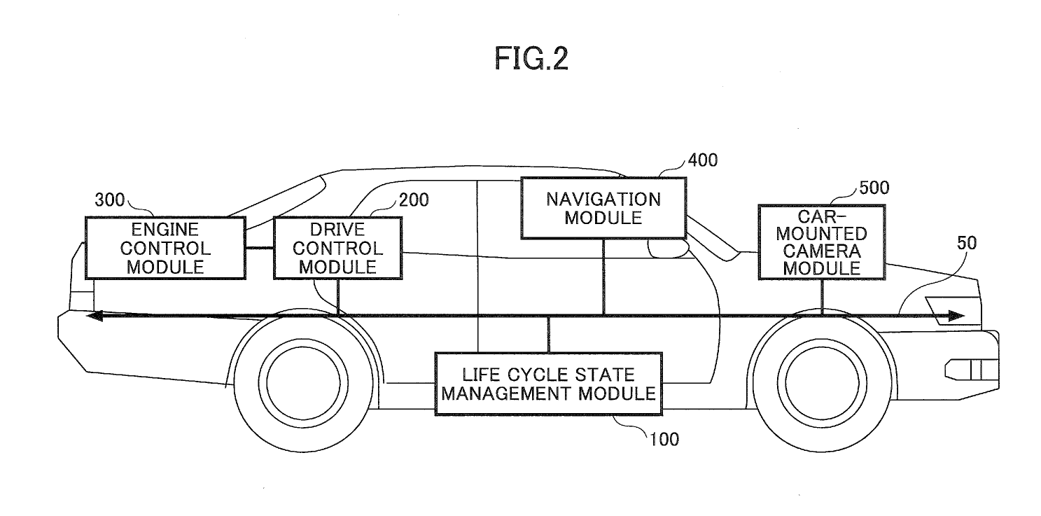

FIG. 2 illustrates a control module configuration of a vehicle provided with a life cycle state management function according to an embodiment. The vehicle according to the present embodiment is constituted by a life cycle state management module 100 for managing the stages (states) of the life cycle of the entire vehicle, and one or more control modules storing data in which the access control policy is defined according to each stage of the life cycle. The life cycle state management module 100 and some of the one or more control modules constitute a network such as a CAN (Controller Area Network), a LIN (Local Interconnect Network), an Ethernet (registered trademark), a LAN (Local Area Network), etc., by being connected by a bus 50. The network is not limited to the above examples; the life cycle state management module 100 and one or more control modules may be connected by FlexRay. In the example of FIG. 2, the life cycle state management module 100 and some of the plurality of control modules are connected by the bus 50. FIG. 2 illustrates, as examples of the plurality of control modules, a drive control module 200, an engine, control module 300, a navigation module 400, and a car-mounted camera module 500.

The life cycle state management module 100 manages the stages of a single life cycle with respect to the entire device, and also manages the authentication information of the device user. The life cycle state management module 100 recognizes the configuration of one or more control modules of the device, and gives control instructions to the one or more control modules. According to each stage of the life cycle, an access control policy (hereinafter, “state access control policy”) set according to each stage of the life cycle of the one or more control modules, is stored in the life cycle state management module 100. The life cycle state management module 100 gives control instructions based on the state access control policy of the control module that is the target of control, and receives requests from the control module that is the target of control, in each stage of the life cycle. According to a request from each control module, the life cycle state management module 100 reports the life cycle state of the device and the role of the person who has made the access to use the device (hereinafter, “accessing person”), via the bus 50. Here, the role indicates the role of the accessing person, and is used for determining whether the accessing person has the authority to make the access. A role may be set for people, or may be set for entities other than people such as a division in a company or a factory.

For example, it is assumed that the control instruction and data for the control module to which a salesman can access in the sales stage 3 of the life cycle, and the control instruction and data for the control module to which a mechanic can access when repair is necessary in the service stage 4 of the life cycle, have different contents. The life cycle state management module 100 manages the authentication information of the accessing person accessing the vehicle (salesman, mechanic), and associates the accessing person accessing the vehicle with the state access control policy. Accordingly, it is possible to prevent a situation where the salesman accesses the information necessary for repair, and damaging the information of the control module that is accessed when the mechanic repairs the vehicle.

The drive control module 200 implements drive control of the vehicle. The engine control module 300 controls the engine of the vehicle. The navigation module 400 performs navigation for guiding the vehicle to the destination. The car-mounted camera module 500 controls a camera mounted on the vehicle.

In the drive control module 200, the engine control module 300, the navigation module 400, and the car-mounted camera module 500, store data in which the state access control policy is defined. The state access control policy describes the role that can make the access, according to each stage in the life cycle. That is, the role that can make the access may change as the stage in the life cycle changes.

The drive control module 200, the engine control module 300, the navigation module 400, and the car-mounted camera module 500 receive, from the life cycle state management module 100 according to need, the stage of the life cycle at that time point and the role of the accessing person, and determine whether access to the data is possible. Based on the stage in the life cycle, the roles that can access the respective control modules mounted on the vehicle are changed all at once. Therefore, it is possible to prevent a situation of forgetting to change the role and incorrectly changing the role, which are likely to occur in a case of making the changes one at a time.

Furthermore, when the life cycle state management module 100 stores data in which the access control policy is defined, there are cases where it is determined whether access to the data is possible, upon receiving the stage in the life cycle of the life cycle state management module 100 and the role of accessing person.

The life cycle state management module 100 and the control modules may be connected such that data can be directly exchanged via the bus 50, such as in the case of the life cycle state management module 100, the drive control module 200, the navigation module 400, and the car-mounted camera module 500. Furthermore, the life cycle state management module 100 may be connected with a particular control module such that data can be indirectly exchanged with another control module via the particular control module, such as in the case of the drive control module 200 and the engine control module 300. Furthermore, in addition to being connected via the bus 50, the life cycle state management module 100 and the control modules may be connected by a cable line such as a network cable or by a wireless network. In any case, there is demand to make a setting such that communication can be performed between the control modules according to a particular protocol.

As described above, the drive control module 200, the engine control module 300, the navigation module 400, and the car-mounted camera module 500 have a state access control policy, and each control module can individually confirm the access authority with respect to data. Other than the method of individually confirming the access authority by each control module, there is a method of providing information in the life cycle state management module 100, in which an identifier of the data held by each control module is associated with the state access control policy of the corresponding data. In this case, the life cycle state management module 100 determines whether there is an access authority based on the state access control policy associated with the data held by each control module, and reports the determination result to each control module. Each control module acquires the determination result sent from the life cycle state management module 100, and can perform operations such as allowing access to the data according to the determination result.

A device that is the target of installing a life cycle state management function indicates a group of all control modules controlled by a common life cycle. That is, when control modules in the vehicle are managed by the same life cycle, the vehicle is the device having the life cycle, and when control modules on a board loaded on a certain commercial material are managed by the same life cycle, the board is the device having the life cycle. This is particularly effective in a case where the shelf life of data stored in each control module installed in the device, matches the shelf life of the device.

### <Hardware Configuration of Life Cycle State Management Module 100>

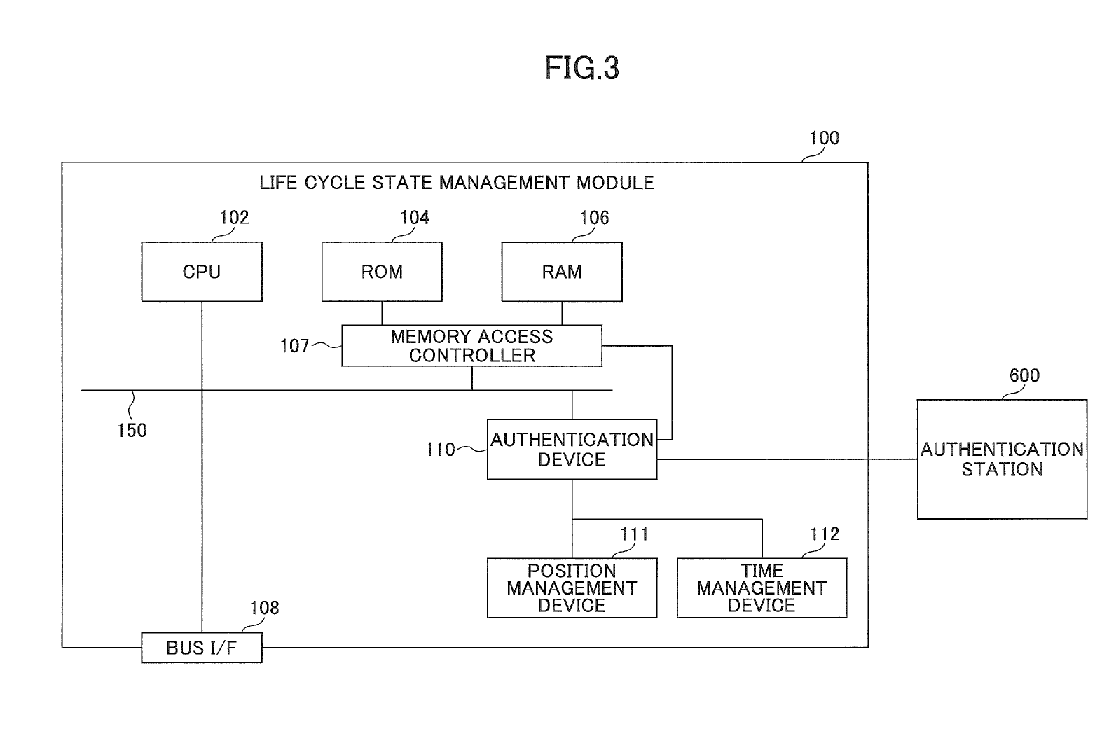

FIG. 3 is a hardware configuration diagram of the life cycle state management module 100 according to the present embodiment. As illustrated in FIG. 3, the life cycle state management module 100 according to the present embodiment includes a CPU (Central Processing Unit) 102, a memory access controller 107, a bus I/F 108, and an authentication device 110 connected to each other by a bus line 150. A ROM (Read-only Memory) 104, and a RAM (Random Access Memory) 106 are connected to the bus line 150 via the memory access controller 107. Furthermore, the life cycle state management module 100 includes a position management device 111 and a time management device 112 that are connected to the authentication device 110. The authentication device 110 also performs communications with an external authentication station 600.

The CPU 102 reads and executes user data, state data, control target data, and programs for the life cycle state management module, which are loaded in one of or both of the ROM 104 and the RAM 106, to provide programmed functions. The user data, state data, control target data, and programs for the life cycle state management module are described below.

The authentication device 110 authenticates the accessing person based on authentication information of the accessing person input from the bus I/F 108. The authentication device 110 authenticates the accessing person who has input the authentication information, based on an access ID, a password, and user data in the authentication information input from the bus I/F 108. Furthermore, the authentication device 110 performs authentication with respect to the position managed by the position management device 111 and the time managed by the time management device 112, based on operation plan information stored in the authentication station 600, and controls the memory access controller 107. When the operation complies with the operation plan information, the authentication device 110 allows the memory access controller 107 to access the ROM 104 and the RAM 106, and when an unauthorized access is detected, the authentication device 110 turns the memory access controller 107 into a locked state. The contents of the operation plan information stored in the authentication station 600, detailed configurations of the position management device 111 and the time management device 112, and contents of control based on the operation plan information are described below.

The authentication device 110 may confirm whether the accessing person has the access authority by methods other than password authentication described above, such as challenge response authentication; a one-time password; biometrics authentication by using biological body information of the human being such as fingerprints, voiceprints, and the iris; and PKI (Public Key Infrastructure). When confirming whether the accessing person has an access authority by PKI, the accessing person requests the authentication station to issue a certificate by submitting a public key. The authentication station examines the accessing person who is the owner of the public key based on application papers that have been submitted, and issues a digital certificate. The digital certificate has attached a digital signature of the authentication station, together with owner information of the public key. The accessing person sends the digital certificate to the life cycle state management module 100. The authentication device 110 of the life cycle state management module 100 decrypts the digital certificate with the public key of the authentication station, and can confirm the information of the accessing person and the signature of the authentication station in the digital certificate, and at the same time obtain the public key of the accessing person. By confirming the information of the accessing person and the signature of the authentication station, the authentication device 110 can confirm whether the accessing person has an access authority.

When the authentication device 110 authenticates that the accessing person is allowed to make an access, the CPU 102 loads the data stored in the ROM 104 into the RAM 106, and provides a programmed function stored in the ROM 104 by reading and executing the data. When the authentication device 110 determines that the accessing person is not allowed to make an access, the CPU 102 can set the entire device (entire vehicle) into a state that cannot be used, based on an instruction from the authentication device 110.

The bus I/F 108 inputs operation signals that are input as the accessing person operates the device from outside the device, and control signals such as a request to change the life cycle state. Furthermore, the bus I/F 108 receives a request to report the life cycle state from another control module connected to the bus 50, and a request to report the role obtained from by the authentication result of the accessing person. Note that a network I/F can be connected, other than the bus I/F 108. The bus I/F 108 may be connected solely, or a plurality of interfaces may be connected such as the bus I/F 108 and a network I/F. Furthermore, the bus I/F 108 may be constituted by a network device, and data may be transmitted in a wireless manner from a mobile terminal such as a smartphone to the network device.

Note that the above programs for a life cycle state management module may be in files having an installable format or an executable format, and may be distributed by being recorded in a computer readable recording medium such as a CD-ROM.

### <Hardware Configuration of Drive Control Module 200>

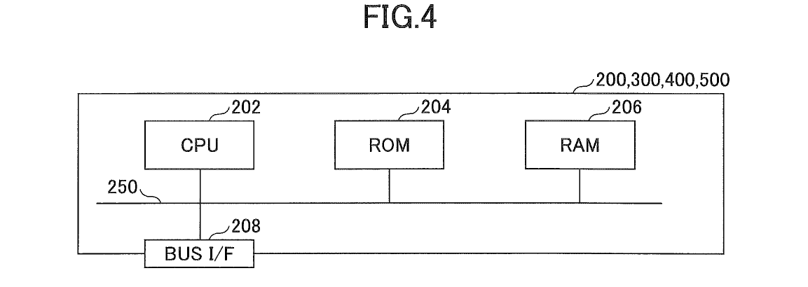

FIG. 4 is a hardware configuration diagram of the drive control module 200 according to the present embodiment. As illustrated in FIG. 4, the drive control module 200 according to the present embodiment includes a CPU 202 for controlling the entire drive control module 200, and a ROM 204 storing programs used for driving the CPU 202 such as IPL. Furthermore, the drive control module 200 includes a RAM 206 used as a work area of the CPU 202, and a bus I/F 208 that is an I/F between the bus 50 and the drive control module 200, which is for outputting operation signals (control signals) from the drive control module 200 to the respective control modules and for receiving access from the control module that is the target of control. Furthermore, the drive control module 200 includes a bus line 250 such an address bus and a data bus, for electrically connecting the above elements as illustrated in FIG. 4. Other hardware blocks may be included in the drive control module 200.

The CPU 202 loads the data stored in the ROM 204 into the RAM 206, and provides a function programmed for a drive control module to be stored in the ROM 204 by reading and executing the data. The program causes the CPU 202 to perform access control based on the life cycle state.

The bus I/F 208 is used as an output unit for outputting a life cycle state report request requesting to report the stage in the life cycle, outside the drive control module 200, and is also used as an input unit for inputting the stage in the life cycle sent from the life cycle state management module 100 in response to the life cycle state report request and a report of the role of the accessing person.

Furthermore, by providing the drive control module 200 with an I/F for receiving input of authentication information of the accessing person, the bus I/F 208 may be used as an output unit for reporting the authentication information to the life cycle state management module 100.

Note that a network I/F can be connected, other than the bus I/F 208. The bus I/F 108 may be connected solely to the drive control module 200, or a plurality of interfaces may be connected by connecting a network I/F in addition to the bus I/F 208.

Note that the above programs for the drive control module may be in files having an installable format or an executable format, and may be distributed by being recorded in a computer readable recording medium such as a CD-ROM.

### <Hardware Configuration of Engine Control Module 300>

The same hardware configuration as that of the drive control module 200 described above can be applied to the engine control module 300. However, the ROM 204 records programs for an engine control module for controlling the engine control module 300. In this case also, the programs for an engine control module may be in files having an installable format or an executable format, and may be distributed by being recorded in a computer readable recording medium such as a CD-ROM.

### <Hardware Configuration of Navigation Module 400>

The same hardware configuration as that of the drive control module 200 described above can be applied to the navigation module 400. However, the ROM 204 records programs for a navigation module for controlling the navigation module 400. In this case also, the programs for a navigation module may be in files having an installable format or an executable format, and may be distributed by being recorded in a computer readable recording medium such as a CD-ROM.

### <Hardware Configuration of Car-Mounted Camera Module 500>

The same hardware configuration as that of the drive control module 200 described above can be applied to the car-mounted camera module 500. However, the ROM 204 records programs for a car-mounted camera module for controlling the car-mounted camera module 500. In this case also, the programs for a car-mounted camera module may be in files having an installable format or an executable format, and may be distributed by being recorded in a computer readable recording medium such as a CD-ROM.

Note that as other examples of the detachable recording medium, the programs may be provided by being recorded in a computer-readable recording medium such as a CD-R (Compact Disc Recordable), a DVD (Digital Versatile Disk), and a blu-ray disc.

### Functional Configuration of Embodiment

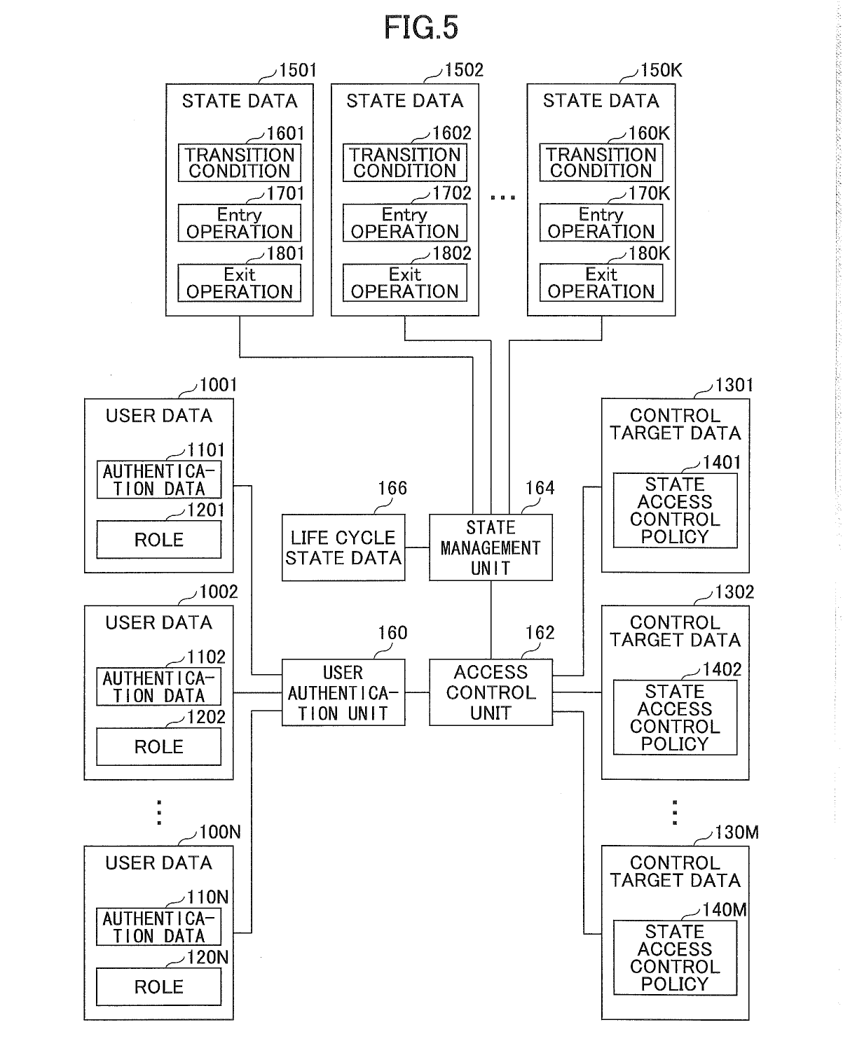

Next, a description is given of a functional configuration of the present embodiment. FIG. 5 is a functional block diagram of the life cycle state management module 100 constituting the device according to the present embodiment. FIG. 5 illustrates the functional block diagram of the life cycle state management module 100, and also the data that is stored in one of or both of the ROM 104 and the RAM 106.

### <Functional Configuration of Life Cycle State Management Module 100>

The life cycle state management module 100 includes a user authentication unit 160, an access control unit 162, and a state management unit 164. These units are functions or functioning units that are realized as any one of the elements illustrated in FIG. 3 is caused to operate by an instruction from the CPU 102 according to a user authentication program, an access control program, and a state management program, which are programs for the life cycle state management module loaded into the RAM 106 from the ROM 104.

That is, the user authentication unit 160 is a function or a functioning unit that is realized by operating by an instruction from the CPU 102 according to a user authentication program that is loaded into the RAM 106 from the ROM 104. Furthermore, the access control unit 162 is a function or a functioning unit that is realized by operating by an instruction from the CPU 102 according to an access control program that is loaded into the RAM 106 from the ROM 104. Furthermore, the state management unit 164 is a function or a functioning unit that is realized by operating by an instruction from the CPU 102 according to a state management program that is loaded into the RAM 106 from the ROM 104. Note that the dependency relationship of the programs is one example; the life cycle state management function may be realized by programs having a different dependency relationship.

### <Functional Units of Life Cycle State Management Module 100>

Next, with reference to FIGS. 3 and 5, a detailed description is given of the functional units of the life cycle state management module 100. Note that in the following, in describing the functional units of the life cycle state management module 100, a description is given of the relationship with the main elements, among the elements illustrated in FIG. 3, for realizing the function units of the life cycle state management module 100.

The user authentication unit 160 illustrated in FIG. 5 is realized by instructions from the CPU 102 illustrated in FIG. 3, the bus I/F 108 illustrated in FIG. 3, and user data 1001-100N (N being an integer of N>0) stored in the ROM 104. The user data 1001-100N may be registered in advance, and N expresses the number of users. Furthermore, the ROM 104 stores authentication data 1101-110N and roles 1201-120N for the respective items of the user data 1001-100N.

The user authentication unit 160 of the life cycle state management module 100 operates as the authentication information of the accessing person is input from the bus I/F 108, and the user authentication unit 160 confirms whether the accessing person has the access authority, based on the authentication information and the authentication data in one of the user data items 1001-100N. The user authentication unit 160 outputs the authentication result of the accessing person, and the role of the accessing person when it is confirmed that the accessing person has an access authority. Specifically, the user authentication unit 160 searches the authentication data 1101-110N of the user data 1001-100N for an access ID included in the authentication information of the accessing person input from the bus I/F 108, and determines whether there is a user that can be authenticated. When there is a user that can be authenticated, the user authentication unit 160 performs the authentication by confirming whether the accessing person has an access authority, by determining whether the password included in the authentication information matches the authentication data of the user data identified as a result of the search. When the user authentication unit 160 confirms that the accessing person has an access authority, the user authentication unit 160 outputs information expressing that the accessing person has an access authority and the role of the accessing person, to the access control unit 162.

The access control unit 162 of the life cycle state management module 100 illustrated in FIG. 5 is realized by instructions from the CPU 102 illustrated in FIG. 3 and control target data 1301-130M (M being an integer of M>0) stored in the ROM 104. Furthermore, the ROM 104 stores state access control policies 1401-140M for the respective items of the control target data 1301-130M. Here, the control target data 1301-130M may be associated with the respective control modules installed in the vehicle, such as the drive control module 200, the engine control module 300, the navigation module 400, and the car-mounted camera module 500. That is, each of the control modules installed in the vehicle includes control data.

The access control unit 162 determines whether the accessing person is able to access the control target data 1301-130M, in a particular life cycle state. The control target data 1301-130M respectively includes state access control policies 1401-140M, and the state access control policies 1401-140M store information of a user capable of access and information of the role capable of access in a particular life cycle state. The access control unit 162 refers to the state access control policies 1401-140M to determine whether the accessing person has the access authority to the control target data. Details of the state access control policies 1401-140M are given below.

Specifically, the access control unit 162 acquires the life cycle state information by calling the state management unit 164, and acquires the role of the corresponding accessing person by calling the user authentication unit 160. The access control unit 162 refers to the state access control policies 1401-140M of the control target data 1301-130M to identify the roles capable of access in the stage of the life cycle acquired from the state management unit 164, and determines whether the accessing person is capable of access by determining whether the role of the accessing person is included in the identified roles, with respect to each control target data item.

The state management unit 164 of the life cycle state management module 100 illustrated in FIG. 5 is realized by instructions from the CPU 102 illustrated in FIG. 3 and state data 1501-150K (K being an integer of K>0) stored in the ROM 104. Here, the state data 1501-150K may be associated with respective control modules installed in the vehicle, such as the drive control module 200, the engine control module 300, the navigation module 400, and the car-mounted camera module 500. Furthermore, the state data 1501-150K may be associated with the control target data 1301-130M. The state data 1501-150K defines the process contents for a case where a request is made for state transition. Furthermore, the ROM 104 stores transition conditions 1601-160K, entry operations 1701-170K, and exit operations 1801-180K, for the respective items of state data 1501-150K.

The transition conditions 1601-160K define conditions that particular data exists, and that the stage in the life cycle is to be transited to another stage when certain data satisfies a particular format. The entry operations 1701-170K define processes for safely using the life cycle after the state transition such as the initial setting of security information. For example, the entry operations 1701-170K define a process for setting a secret key, etc., used for communication. The exit operations 1801-180K define processes for erasing information if leaving the information when shifting to the next state would lead to vulnerability in security, or rewriting such information that would lead to vulnerability in security, when changing the state in the life cycle. For example, the entry operations 1701-170K define a setting for deleting log data that leads to personal information of a main user of the device in the previous life cycle state, or a setting for prohibiting writing to prevent the secret key from being tampered.

The state management unit 164 refers to life cycle state data 166 in response to an access request from the access control unit 162, acquires the stage in the life cycle at the time point of the access request, and reports the acquired stage to the access control unit 162. Here, the life cycle state data 166 is data indicating the stage in the life cycle at the particular time point in the entire device, and only one item of the life cycle state data 166 is managed throughout the entire device. The life cycle state data 166 is changed every time state transition is performed, by which the stage in the life cycle is changed. For example, in each stage of the life cycle, the life cycle state data 166 may be changed by the person changing the stage. The state management unit 164 executes the process defined in the state data 1501-150K, when state transition is requested.

### <Functional Configuration of Drive Control Module 200>

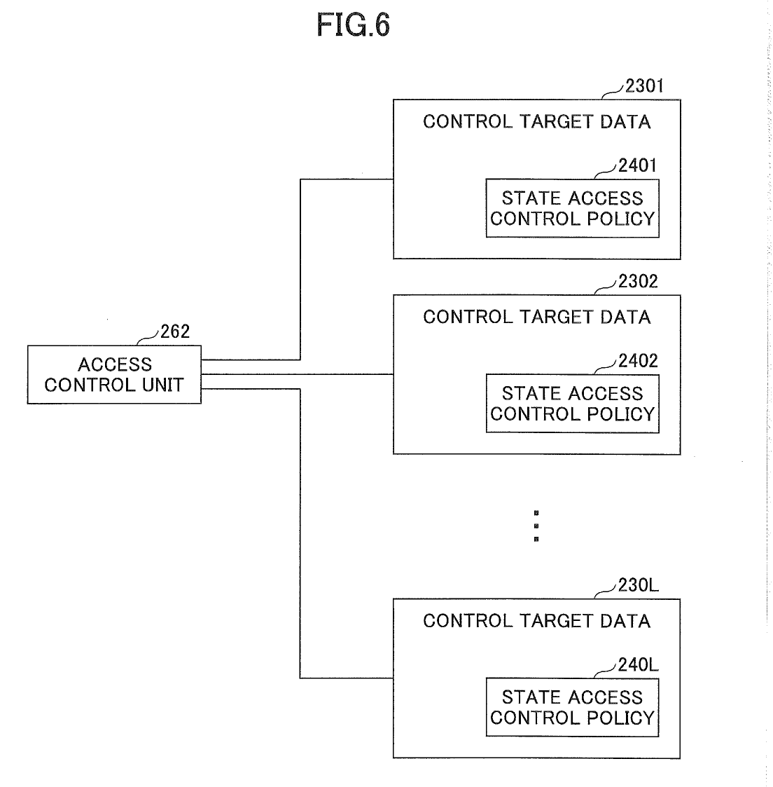

Next, a description about the functional configuration according to the present embodiment is continued. FIG. 6 a functional block diagram of the drive control module 200 constituting the device according to the present embodiment. FIG. 6 illustrates the functional block diagram of the drive control module 200 together with data stored in one of or both of the ROM 204 and the RAM 206.

The drive control module 200 includes an access control unit 262, and this access control unit 262 is a function or a function means that is realized as any one of the configuration elements in FIG. 4 operates according to an instruction from the CPU 202 according to an access control program, which is a program used for the drive control module loaded from the ROM 204 to the RAM 206.

That is, the access control unit 262 is a function or a function means that is realized by operating according to an instruction from the CPU 202 according to an access control program loaded from the ROM 204 to the RAM 206.

### <Functional Units of Drive Control Module 200>

Next, with reference to FIGS. 4 and 6, a detailed description is given of the functional units of the drive control module 200. Note that in the following, in describing the functional units of the drive control module 200, a description is given of the relationship with the main elements, among the elements illustrated in FIG. 4, for realizing the function units of the drive control module 200.

The access control unit 262 of the drive control module 200 illustrated in FIG. 6 is realized by instructions from the CPU 202 illustrated in FIG. 4 and control target data 2301-230L (L being an integer of L>0) stored in the ROM 204. Furthermore, the ROM 204 stores state access control policies 2401-240L for the respective items of the control target data 2301-230L. Here, the control target data 2301-230L may be associated with the respective control modules installed in the vehicle, such as the engine control module 300, the navigation module 400, and the car-mounted camera module 500. That is, each of the control modules installed in the vehicle includes control data.

The access control unit 262 determines whether the accessing person is able to access the control target data 2301-230L, in a particular life cycle state. The control target data 2301-230L respectively includes state access control policies 2401-240L, and the state access control policies 2401-240L store information of a user capable of access and information of the role capable of access in a particular life cycle state. The access control unit 262 refers to the state access control policies 2401-240L to determine whether the accessing person has the access authority to the control target data.

Specifically, the access control unit 262 requests the life cycle state management module 100 to report the life cycle state and to report the role of the accessing person, via the bus I/F 208. The access control unit 262 acquires, from the bus I/F 208, the life cycle state and the role of the accessing person sent from the life cycle state management module 100. The access control unit 262 refers to the state access control policies 2401-240L of the control target data 2301-230L, to identify the roles capable of access in the stage of the life cycle acquired from the life cycle state management module 100, and determines whether the accessing person is capable of access by determining whether the role of the accessing person is included in the identified roles, with respect to each control target data item.

<Process where Life Cycle State is Changed>

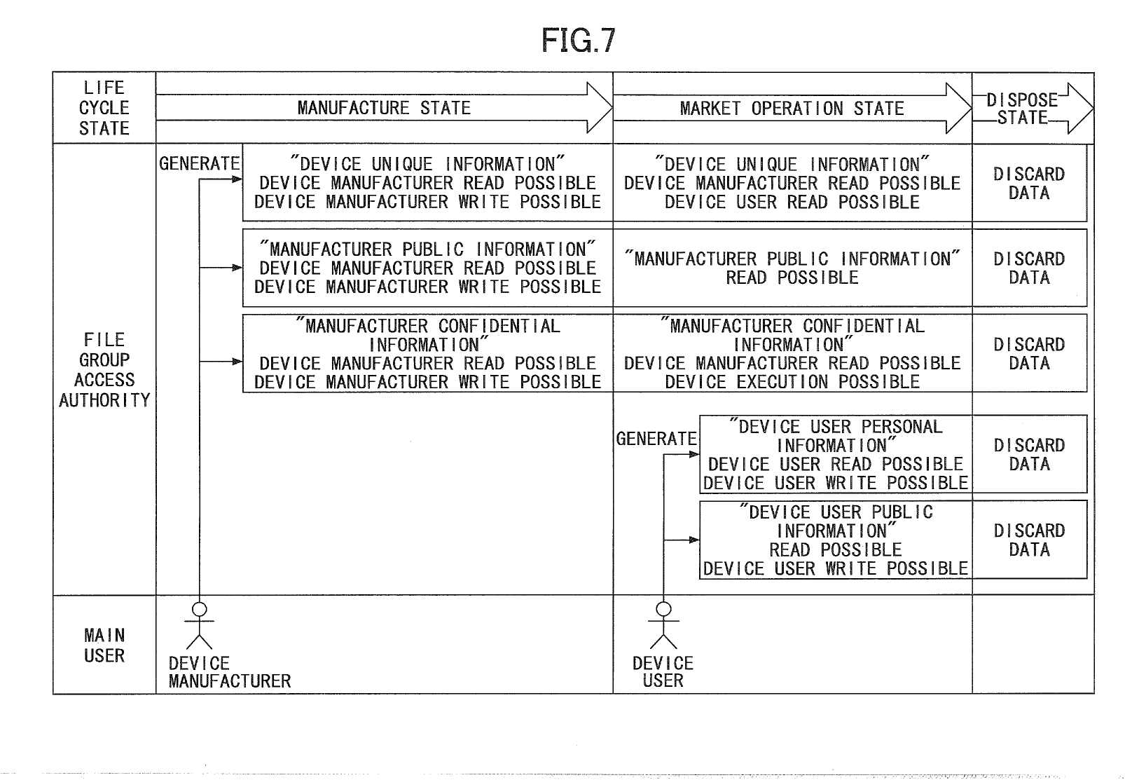

FIG. 7 illustrates a process where the life cycle state is changed. In FIG. 7, the stages of the life cycle of a device are changed in the order of the manufacture state, the market operation state, and the dispose state. When the stage of the life cycle is changed, the contents of the access authority to the control target data and the person for which the access authority can be set, are changed. This is one example in which the stages of the life cycle are changed in the order of the manufacture state, the market operation state, and the dispose state; another stage (state) may also be included in the life cycle. For example, a life cycle for returning from the market operation state to the manufacture state for the purpose of recycling, may be included in the life cycle.

The manufacture state is a state before shifting to the market operation state, and necessary settings are made for the device. In the example illustrated in FIG. 7, the device manufacturer can generate and implement, in the device, “device unique information” as information for identifying the individual device, and “manufacturer public information” and “manufacturer confidential information” as information for authenticating the device manufacturer. In the manufacture state, the device manufacturer is set as read, write (generate) possible (READ, WRITE possible), with respect to the “device unique information”, the “manufacturer public information”, and the “manufacturer confidential information”.

When transition from the manufacture state to the market operation state becomes possible, state transition is performed, and the state shifts to the market operation state. In the example illustrated in FIG. 7, by shifting from the manufacture state to the market operation state, the main user changes from the device manufacturer to the device user, and therefore the authentication information set by the device user is used to manage the device. The device user can generate and implement, in the device, “device user personal information” as personal information of the device user, and “device user public information” as public information of the device user. In the market operation state, the device user is set as read, write (generate) possible (READ, WRITE possible), with respect to the “device user personal information” and “device user public information”. Furthermore, with respect to “device user public information”, people other than the device user are also set as read possible (READ possible).

In the market operation state, the device manufacturer cannot read the “device user personal information”, and therefore even when the device user does not trust the device manufacturer, safety of the device can be secured. Conversely, the device user cannot read the “manufacturer confidential information”, and therefore even when the device manufacturer does not trust the device user, the safety of the device manufacturer can be secured.

Furthermore, in the market operation state, with respect to the “device unique information”, the device manufacturer and the device user are set as read possible (READ possible), with respect to “manufacturer public information”, all accessing persons are set to read possible (READ possible), and with respect to “manufacturer confidential information”, the device manufacturer is set as read possible (READ possible). Furthermore, “manufacturer confidential information” is set to be executable by the device. That is, in the market operation state, a setting is made such that the “manufacturer confidential information” cannot be read (generated), such that the device manufacturer is imposed of the obligation of non-repudiation.

When it is possible to transit from the market operation state to the dispose state, state transition is performed, and the state shifts to the dispose state. In the example illustrated in FIG. 7, as the entry process when the life cycle state changes from the market operation state to the dispose state, a setting is made to discard all data. Accordingly, after disposing the device, it is possible to prevent the confidential information and personal information stored in the device from being stolen. For example, in order to prevent the confidential information and personal information stored in the device from being stolen after disposing the device, all data is disposed by being erased by overwriting the information stored in the device with “new data”.

Based on the stages of the life cycle, all data of the device can be managed, and therefore a situation of forgetting to discard particular data will not occur, which is likely to occur when the respective data items of the device are separately managed. Furthermore, stage change is performed at once on all data relevant to the life cycle, and therefore it is possible to reduce the risk of unintentionally raising the level of access authority, which is likely to occur by incorrectly changing the access authority of a particular data item.

### <State Access Control Policy>

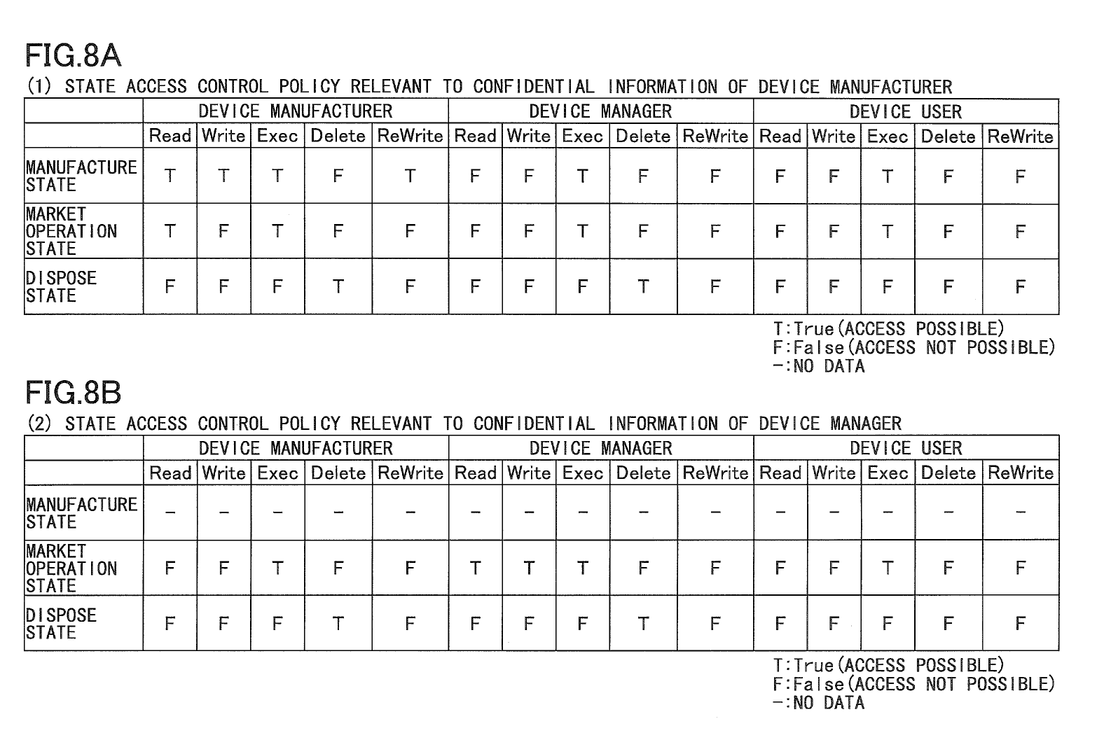

FIGS. 8A through 8F illustrate examples of the state access control policies 1401-140M stored in the control target data 1301-130M of the life cycle state management module 100. FIGS. 8A through 8F are also applicable to the state access control policies 2401-240L stored in the control target data 2301-230L of the drive control module 200, the engine control module 300, the navigation module 400, and the car-mounted camera module 500.

The control target data 1301-130M that is the target of management by the life cycle state management module 100 include the state access control policies 1401-140M, respectively. An example of the state access control policies 1401-140M is a matrix table constituted by access contents associated with the stages of the life cycle of the device and the role of the accessing person.

However, it is possible to use the identification information (ID) of a particular user, instead of the role of the accessing person. Accordingly, the user and the access content can be associated with each other, and therefore an access content, which is different from that given to other users, can be given to a particular user. Specifically, a strong access authority by which many accesses are possible, can be given to a particular user. Furthermore, by integrating the roles of the accessing persons, a group of accessing persons can be created. By using a group of accessing persons, it is possible to associate a group of accessing persons with access contents, and therefore a strong access authority by which many accesses are possible, can be given to a particular group of accessing persons.

Details are Described Below.

Examples of types of access contents of the access authority assigned to the role of each accessing person and descriptions thereof are given below.

(1) “Read”: The target control target data can be read.
(2) “Write”: The target control target data can be written (generated).
(3) “Exec”: The target control target data can be used.
(4) “Delete”: The target control target data can be deleted.
(5) “Rewrite”: The target control target data can be changed.

The state access control policy with respect to each control target data item is created for each control target data item.

In the example of FIGS. 8A through 8F, as examples of roles of accessing persons, a device manufacturer, a device manager, and a device user are assumed, and as examples of stages of the life cycle, a manufacture state, a market operation state, and a dispose state are assumed. Furthermore, as for the control target data, setting examples of access control policies of confidential information of the roles of the respective accessing persons, and access control policies of public information of the roles of the respective accessing persons, are indicated.

FIG. 8A indicates (1) the state access control policy relevant to the confidential information of the device manufacturer, FIG. 8B indicates (2) the state access control policy relevant to the confidential information of the device manager, and FIG. 8C indicates (3) the state access control policy relevant to the confidential information of the device user. Furthermore, FIG. 8D indicates (4) the state access control policy relevant to the public information of the device manufacturer, FIG. 8E indicates (5) the state access control policy relevant to the public information of the device manager, and FIG. 8F indicates (6) the state access control policy relevant to the public information of the device user.

As indicated in FIG. 8A (1) and FIG. 8D (4), the information owned by the device manufacturer is the “manufacturer confidential information” and the “manufacturer public information”. That is, the device manufacturer can generate the “manufacturer confidential information” and the “manufacturer public information” in the manufacture state, and introduce the generated information in the device.

A description is given of the “manufacturer confidential information”.

In the manufacture state, the device manufacturer is able to read (“Read”), write (“Write”), use (“Exec”), and change (“ReWrite”) the “manufacturer confidential information”, and the device manager and the device user are able to use (“Exec”) the “manufacturer confidential information”.

When the state shifts from the manufacture state to the market operation state, the life cycle state management module 100 performs access control such that the device manufacturer is unable to write (“Write”) or change (“ReWrite”) the “manufacturer confidential information”. Accordingly, after shifting to the market operation state, the device manufacturer is prevented from tampering the confidential information in the device without permission, and therefore it is possible for non-repudiation of a process executed by using the confidential information.

In the market operation state, the device manager and the device user are able to use (“Exec”) the “manufacturer confidential information”. However, the “manufacturer confidential information” includes information for which only the device manufacturer himself has the usage (“Exec”) authority, such as a secret key for a signature of the device manufacturer.

When it is possible to transit from the market operation state to the dispose state, state transition is performed, and the state shifts to the dispose state. The life cycle state management module 100 performs access control such that the device manufacturer cannot read (“Read”) or use (“Exec”) the “manufacturer confidential information”, and performs access control such that the device manufacturer can delete (“Delete”) the “manufacturer confidential information”. The device manufacturer can dispose the device by deleting (“Delete”) the “manufacturer confidential information”. Accordingly, after the device is disposed, the “manufacturer confidential information” stored in the device is prevented from being stolen. Furthermore, from the viewpoint of safety, in the dispose state, the life cycle state management module 100 can perform access control such that the device manager can delete (“Delete”) the “manufacturer confidential information”.

A description is given of the “manufacturer public information”.

In the manufacture state, the device manufacturer is able to read (“Read”), write (“Write”), use (“Exec”), and change (“ReWrite”) the “manufacturer public information”, and the device manager and the device user are able to read (“Read”), and use (“Exec”) the “manufacturer public information”.

When the state shifts from the manufacture state to the market operation state, the life cycle state management module 100 performs access control such that the device manufacturer is unable to write (“Write”) or change (“ReWrite”) the “manufacturer public information”. Accordingly, after shifting to the market operation state, the device manufacturer is prevented from tampering the public information in the device without permission, and therefore it is possible for non-repudiation of a process executed by using the public information.

In the market operation state, the device manager and the device user are able to read (“Read”) and use (“Exec”) the “manufacturer public information”.

When it is possible to transit from the market operation state to the dispose state, state transition is performed, and the state shifts to the dispose state. The life cycle state management module 100 performs access control such that the device manufacturer is unable to read (“Read”) or use (“Exec”) the “manufacturer public information”, and performs access control such that the device manufacturer is able to delete (“Delete”) the “manufacturer public information”. The device manufacturer can dispose the device by deleting (“Delete”) the “manufacturer public information”. Accordingly, after the device is disposed, the “manufacturer public information” stored in the device is prevented from being stolen. Furthermore, from the viewpoint of safety, in the dispose state, the life cycle state management module 100 can perform access control such that the device manager can delete (“Delete”) the “manufacturer public information”.

As indicated in FIG. 8B (2) and FIG. 8E (5), the information owned by the device manager is the “manager confidential information” and the “manager public information”. That is, the device manager can generate the “manager confidential information” and the “manager public information” in the market operation state, and introduce the generated information in the device.

A description is given of the “manager confidential information”.

In the market operation state, the device manager is able to read (“Read”), write (“Write”), and use (“Exec”) the “manager confidential information”, and the device manufacturer and the device user are able to read (“Read”), and use (“Exec”) the “manager confidential information”. The “manager confidential information” includes information for which only the device manager himself has the usage (“Exec”) authority, such as a secret key for a signature of the device manager. Accordingly, the “manager confidential information” can be protected from users other than the device manager such as the device manufacturer, and therefore the life cycle state management module 100 can be safely used.

When it is possible to transit from the market operation state to the dispose state, state transition is performed, and the state shifts to the dispose state. The life cycle state management module 100 performs access control such that the device manager is unable to read (“Read”), write (“Write”), or use (“Exec”) the “manager confidential information”, and performs access control such that the device manager is able to delete (“Delete”) the “manager confidential information”. The device manager can dispose the device by deleting (“Delete”) the “manufacturer public information”. Accordingly, after the device is disposed, the “manufacturer public information” stored in the device is prevented from being stolen. Furthermore, from the viewpoint of safety, in the dispose state, the life cycle state management module 100 can perform access control such that the device manufacturer can delete (“Delete”) the “manager confidential information”.

A description is given of the “manager public information”.

In the market operation state, the device manager is able to read (“Read”), write (“Write”), and use (“Exec”) the “manager public information”, and the device manufacturer and the device user are able to read (“Read”), and use (“Exec”) the “manager public information”.

When it is possible to transit from the market operation state to the dispose state, state transition is performed, and the state shifts to the dispose state. The life cycle state management module 100 performs access control such that the device manager is unable to read (“Read”), write (“Write”), or use (“Exec”) the “manager public information”, and performs access control such that the device manager is able to delete (“Delete”) the “manager public information”. The device manager can dispose the device by deleting (“Delete”) the “manager public information”. Accordingly, after the device is disposed, the “manager public information” stored in the device is prevented from being stolen. Furthermore, from the viewpoint of safety, in the dispose state, the life cycle state management module 100 can perform access control such that the device manufacturer can delete (“Delete”) the “manager public information”.

As indicated in FIG. 8C (3) and FIG. 8F (6), the information owned by the device user is the “user confidential information” and the “user public information”. That is, the device user can generate the “user confidential information” and the “user public information” in the market operation state, and introduce the generated information in the device.

A description is given of the “user confidential information”.

In the market operation state, the device user and the device manager are able to read (“Read”), write (“Write”), and use (“Exec”) the “user confidential information”, and the device manufacturer is able to use (“Exec”) the “user confidential information”. The “user confidential information” includes information for which only the device user himself has the usage (“Exec”) authority, such as a secret key for a signature of the device user. Accordingly, the “user confidential information” can be protected from the device manufacturer, the device manager, and users other than the device user, and therefore the life cycle state management module 100 can be safely used.

Here, as to whether the device manager can read (“Read”) and write (“Write”) the “user confidential information”, a setting can be made according to the operation of the life cycle state management module 100. For example, when the device manager has a strong access authority, a setting is made such that the device manager can read (“Read”) the “user confidential information”, but when the device manager has an access authority that is close to and similar to that of the device user, a setting is made such that the device manager cannot read (“Read”) the “user confidential information”.

When it is possible to transit from the market operation state to the dispose state, state transition is performed, and the state shifts to the dispose state. The life cycle state management module 100 performs access control such that the device user and the device manager cannot read (“Read”), write (“Write”), or use (“Exec”) the “user confidential information”, and performs access control such that the device user and the device manager can delete (“Delete”) the “user confidential information”, and dispose the device. The device user and the device manager can dispose the device by deleting (“Delete”) the “user confidential information”. Accordingly, after the device is disposed, the “user confidential information” stored in the device is prevented from being stolen. Furthermore, from the viewpoint of safety, in the dispose state, the life cycle state management module 100 can perform access control such that the device manufacturer can delete (“Delete”) the “user confidential information”.

A description is given of the “user public information”.

In the market operation state, the device user and the device manager are able to read (“Read”), write (“Write”), and use (“Exec”) the “user public information”, and the device manufacturer is able to use (“Exec”) the “user public information”.

Here, as to whether the device manager can read (“Read”) and write (“Write”) the “user public information”, a setting can be made according to the operation of the life cycle state management module 100. For example, when the device manager has a strong access authority, a setting is made such that the device manager can read (“Read”) and write (“Write”) the “user public information”, but when the device manager has an access authority that is close to and similar to that of the device manufacturer, a setting is made such that the device manager cannot read (“Read”) the “user public information”.

When it is possible to transit from the market operation state to the dispose state, state transition is performed, and the state shifts to the dispose state. The life cycle state management module 100 performs access control such that the device user and the device manager are unable to read (“Read”), write (“Write”), or use (“Exec”) the “user public information”, and performs access control such that the device user and the device manager are able to delete (“Delete”) the “user public information”. The device manager and the device manager can dispose the device by deleting (“Delete”) the “user public information”. Accordingly, after the device is disposed, the “user public information” stored in the device is prevented from being stolen. Furthermore, from the viewpoint of safety, in the dispose state, the life cycle state management module 100 can perform access control such that the device manufacturer can delete (“Delete”) the “user public information”.

### <Access Process to Control Target Data>

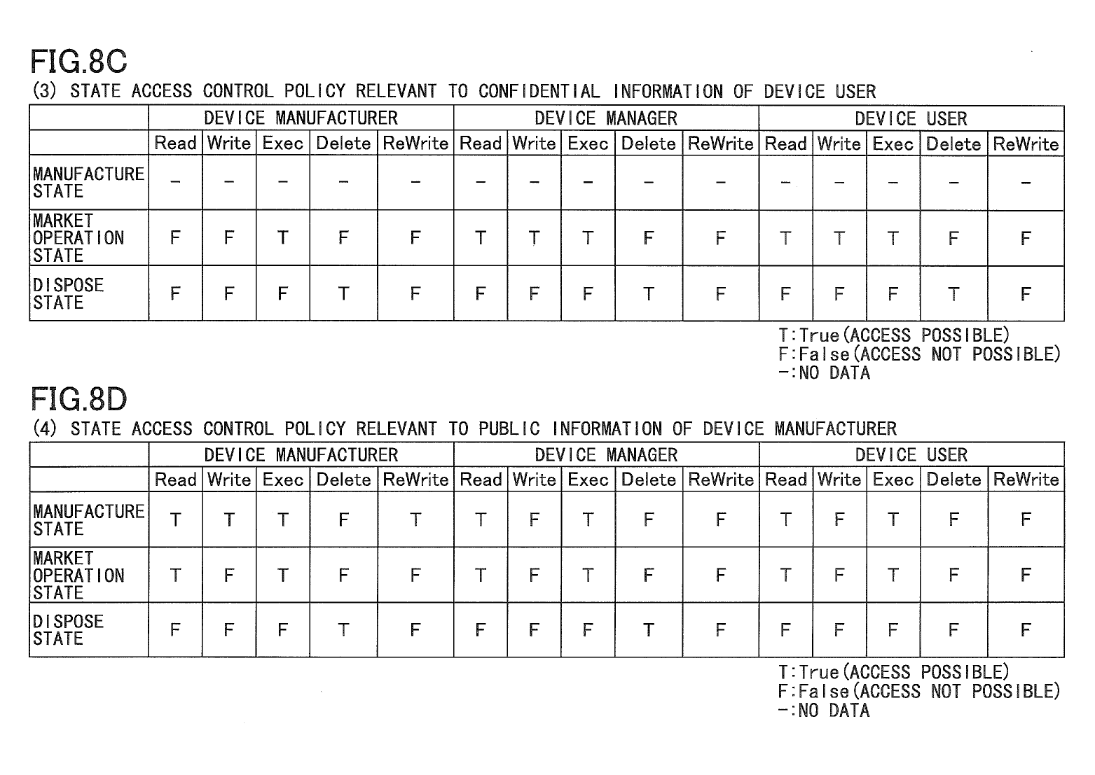

FIG. 9 is a flowchart of an access process to control target data.

When access to control target data is requested, the access control unit 162 of the life cycle state management module 100 makes a decision as to whether to approve or reject the access to the control target data. Note that as various programs are also stored as control target data in the ROM 104, an access process to control target data is principally requested for accessing all control target data, including access by operations for executing various programs. However, this does not apply to programs related to executing a data access sequence such as an access control program, a state management program, and a user authentication program; these programs may be used by an arbitrary accessing person.

Here, a description is given of a case where an accessing person makes a request to access control target data 130M.

In step S902, when an access request to the control target data 130M is made, the access control unit 162 calls the state management unit 164 in order to confirm the present life cycle state. In response to the call from the access control unit 162, the state management unit 164 acquires life cycle state information from the life cycle state data 166, and sends the life cycle state information to the access control unit 162. The access control unit 162 can confirm the present life cycle state by acquiring the life cycle state information from the state management unit 164.

In step S904, the access control unit 162 refers to the part of the present life cycle state in the state access control policy 140M of the control target data 130M.

In step S906, the access control unit 162 determines whether there is information in which an authority capable of access is set, in the part of the present life cycle state of the state access control policy 140M of the control target data 130M.

In step S908, when there is information in which an authority capable of access is set, in the part of the present life cycle state of the state access control policy 140M of the control target data 130M, the access control unit 162 determines whether access is possible even when there is no authority to the control target data 130M.

When it is determined that access is not possible when there is no authority to the control target data 130M in step S908, in step S910, the user authentication unit 160 authenticates the accessing person. That is, the user authentication unit 160 performs the authentication on the accessing person when the access control unit 162 determines that state access control policy 140M has a setting of access control according to a role to access the control target data 130M, and that it is necessary to confirm the role. When authenticating the accessing person, the user authentication unit 160 requests the identification information of the accessing person and the authentication information of the accessing person, and the identification information of the accessing person and the authentication information of the accessing person are input from the bus I/F 108. For example, an input device is connected to the bus I/F 108, and password authentication can be applied by inputting a user ID and a password.

In step S912, the user authentication unit 160 determines whether the authentication of the accessing person is successful.

In step S914, when the user authentication unit 160 determines that the authentication of the accessing person is successful, the user authentication unit 160 inputs the role of the accessing person in the access control unit 162. The access control unit 162 determines whether the accessing person has the authority to access the control target data 130M, based on the role of the accessing person. The access control unit 162 identifies the roles capable of access in the stage of the life cycle acquired from the state management unit 164, and determines whether the identified roles include the role of the accessing person, to determine whether the accessing person is capable of access.

When it is determined that the accessing person is capable of access in step S914, or when it is determined that access is possible even when there is no authority to the control target data 130M in step S908, in step S916, the access control unit 162 approves of the data access for the accessing person.

When it is determined that an authority capable of access is not set in the state access control policy 140M of the control target data 130M in step S906, in step S918, before authenticating the accessing person, the access control unit 162 rejects access to the data by the accessing person. In one example, when there is manufacturer confidential information, e.g., a file that writing is not allowed such as the public key information of the manufacturer, the access control unit 162 rejects the access request for writing into the manufacturer confidential information.

Furthermore, when it is not determined that the authentication of the accessing person is successful by the user authentication unit 160 in step S912, in step S918, the user authentication unit 160 inputs a result indicating that authentication is unsuccessful to the access control unit 162. When a result indicating that authentication is unsuccessful is acquired from the user authentication unit 160, the access control unit 162 rejects the access to the data by the accessing person.

Furthermore, when it is determined that the accessing person is not capable of access in step S914, in step S918, the access control unit 162 rejects the access to the data by the accessing person.

The order of processes indicated in the flowchart of FIG. 9 is not limited to the above and may be changed according to need. For example, the process of step S910 may be performed before the process of step S902.

Furthermore, part of the processes indicated in the flowchart of FIG. 9 may be applied to the process by the drive control module 200. That is, the life cycle state management module 100 reports the life cycle state to the drive control module 200 after the process of step S902.

The access control unit 262 of the drive control module 200 performs the processes of steps S904 through S908 based on the life cycle state reported from the life cycle state management module 100. The access control unit 262 of the drive control module 200 allows the access to the control target data when the control target data can be accessed without an authority, and when the control target data cannot be accessed without an authority, the access control unit 262 sends a report to the life cycle state management module 100.

When a report that the control target data cannot be accessed without an authority is received, the life cycle state management module 100 performs the processes of steps S910 through S912. When the authentication is unsuccessful, the life cycle state management module 100 rejects the access, and when the authentication is successful, the life cycle state management module 100 sends a report to the drive control module 200.

When a report that the authentication is successful is received, the access control unit 262 of the drive control module 200 determines whether the authenticated person has an access authority to the control target data, and performs the process of step S916 or S918.

Furthermore, part of the processes indicated in the flowchart of FIG. 9 may be applied to the process by the engine control module 300, the navigation module 400, and the car-mounted camera module 500, similar to the drive control module 200.

### <Process of Changing Life Cycle State>

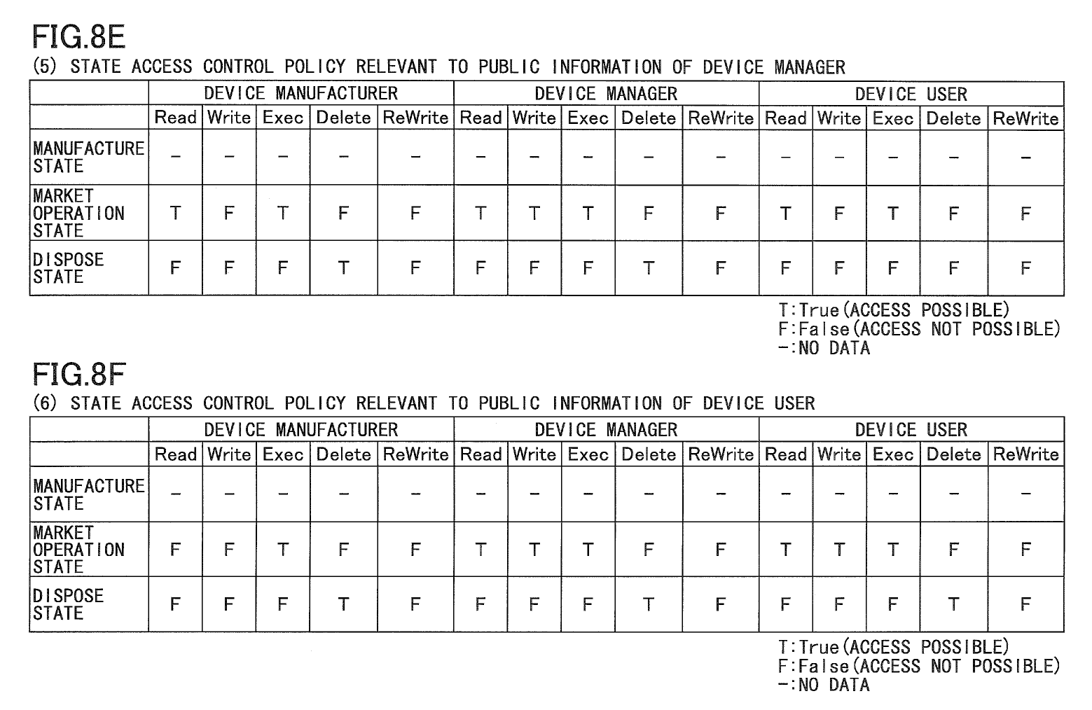

FIG. 10 illustrates a process of changing the life cycle state.

In step S1002, the access control unit 162 of the life cycle state management module 100 receives a request to change the life cycle state (hereinafter, “state change request”).

In step S1004, the access control unit 162 of the life cycle state management module 100 determines whether the accessing person that has made the state change request is the person for whom access has been allowed. The access control unit 162 performs a process of changing the life cycle state according to the state change request after implementing access control to the data. Specifically, the access control unit 162 executes an access process to the control target data illustrated in FIG. 9, when the state change request is received. The access control unit 162 performs a process of changing the life cycle state when access to the control target data is approved, and when access is not approved, the access control unit 162 rejects the process of changing the life cycle state.

In step S1006, when the accessing person who has made the state change request is a person for whom access is allowed in step S1004, the state management unit 164 searches the transition condition. When the state change request is received, the access control unit 162 calls the state management unit 164, and requests a report of the transition condition in the state when the state change request has been made. The state management unit 164 reports the transition condition according to request for the report of the transition condition from the access control unit 162. The transition condition is that particular data exists, or certain data satisfies a particular format, etc. Here, as one example, a description is given of a case where the transition condition is to acquire the hash values of all data stored in the ROM 104, and to confirm that the data has not been tampered.

In step S1008, the access control unit 162 determines whether the transition condition for state change is satisfied, based on the transition condition reported from the state management unit 164. Here, the transition condition is to acquire the hash values of all data stored in the ROM 104, and to confirm that the data has not been tampered, and therefore the access control unit 162 acquires the hash values of all data stored in the ROM 104 such as the control target data 1301-130M, and determines whether the data has been tampered, to determine whether the transition condition of state change is satisfied.

In step S1010, when it is determined that the data has not been tampered in step S1008, that is, when the state change condition is satisfied, the access control unit 162 performs a process of exiting from the state before state change. When the state change condition is satisfied, the access control unit 162 calls the state management unit 164, and requests the state management unit 164 to report the exit operation of the state data before state transition. The state management unit 164 reports the exit operation of the state data before state transition, according to the request to report the exit operation from the access control unit 162. The access control unit 162 performs an exit process according to the exit operation reported from the state management unit 164. By performing the exit process, when changing the life cycle state, it is possible to erase information if leaving the information when shifting to the next state would lead to vulnerability in security, or it is possible to rewrite such information. Examples of an exit process would be to delete log data leading to personal information of a major user of the device in the previous life cycle state, and to make an unwritable setting for preventing tampering of the secret key.

After the exit process is performed in step S1010, in step S1012, the access control unit 162 performs state change. The access control unit 162 reports the change of the state to the state management unit 164. When the change in the state is reported from the access control unit 162, the state management unit 164 transits the state that is the management target, by replacing the contents stored as the present state with the requested state.

In step S1014, the entry process to the state after state change is performed. After the state change, the access control unit 162 calls the state management unit 164, and requests the entry operation. The state management unit 164 reports the entry operation according to the request to report the entry operation from the access control unit 162. The access control unit 162 performs the entry process according to the entry operation reported from the state management unit 164. In the entry process, as a process for safely using the life cycle after state change, the initial setting of security information is made. One example is to perform a process of automatically generating a key by the device, in a case where a setting of a key for communication is needed.

After the entry process is performed in step S1014, in step S1016, the state change is completed.

When it is determined in step S1004 that the accessing person who made the state change request is not a person for whom access has been allowed, or when it is determined in step S1008 that the data has been tampered, in step S1018, the access control unit 162 rejects the state change request.

The order of processes indicated in the flowchart of FIG. 10 is not limited to the above and may be changed according to need.

### <Control Based on Operation Plan Information>

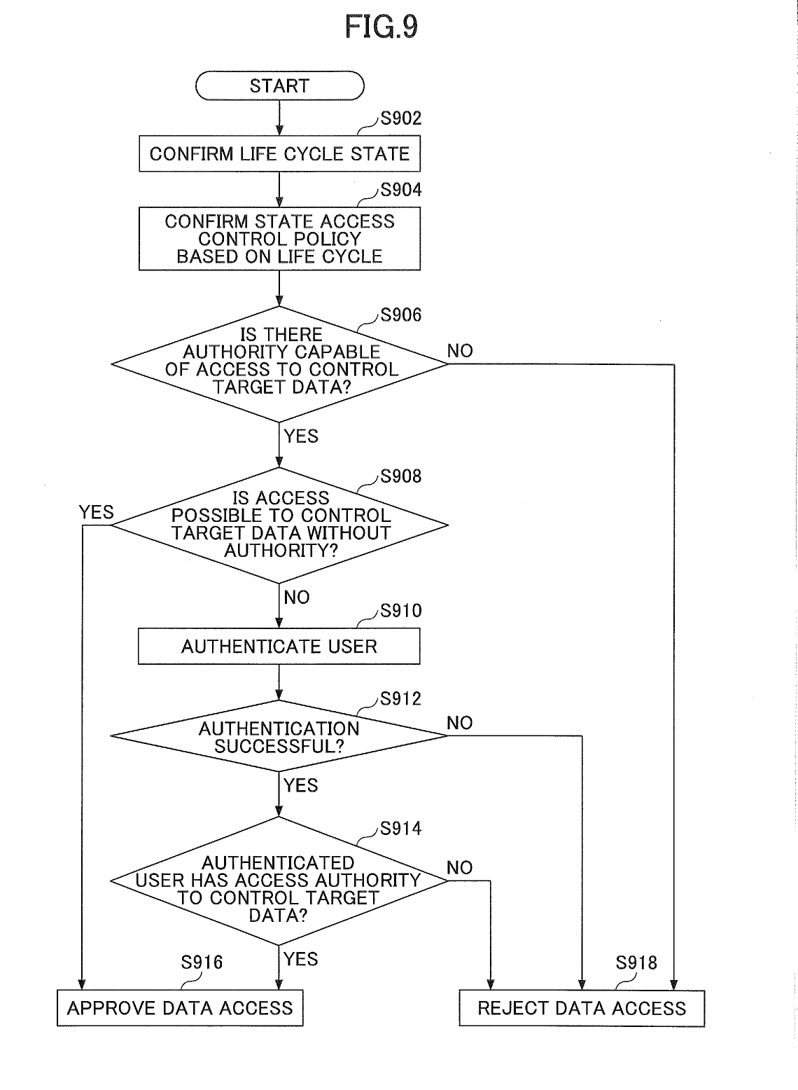

FIG. 11 illustrates an example of operation plan information held by the authentication station 600. In FIG. 11, the operation plan information holds the latitude, the longitude, the start time, and the completion time, in association with the stages of the life cycle. The latitude and the longitude are handled as position registration information by the position management device 111. The start time and the completion time are handled as calendar information by the time management device 112.

Furthermore, as for the stages of the life cycle, management is also performed during the transition of the stages, and therefore there are intermediate states such as “manufacture→sales” and “sales→maintenance”. This information is unnecessary for applying the state access control policy by the life cycle state management module 100. Note that these intermediate states may be used for controlling the access from a device.

In the operation plan information, there is no need to always set both the position registration information (latitude and longitude) and the calendar information (start time and completion time); there may be cases where only the position registration information is set, and there may be cases where only the calendar information is set. FIG. 11 indicates information that is determined at the manufacture stage, and the information may be updated as the stages proceed. For example, in the maintenance stage, the service starts from the time when the product is sold to the customer, and therefore the start time is unknown at the manufacture stage, and the start time is indicated as “-”. This information may be handled as information that can only be updated by the dealer, and a means may be provided for updating the information based on a plan up to the delivery at the time of sales.

FIG. 11 illustrates a basic data configuration; according to need, information may be added for identifying the position information in more detail, the range of the position may be specified, and a plurality of time information items may be handled.

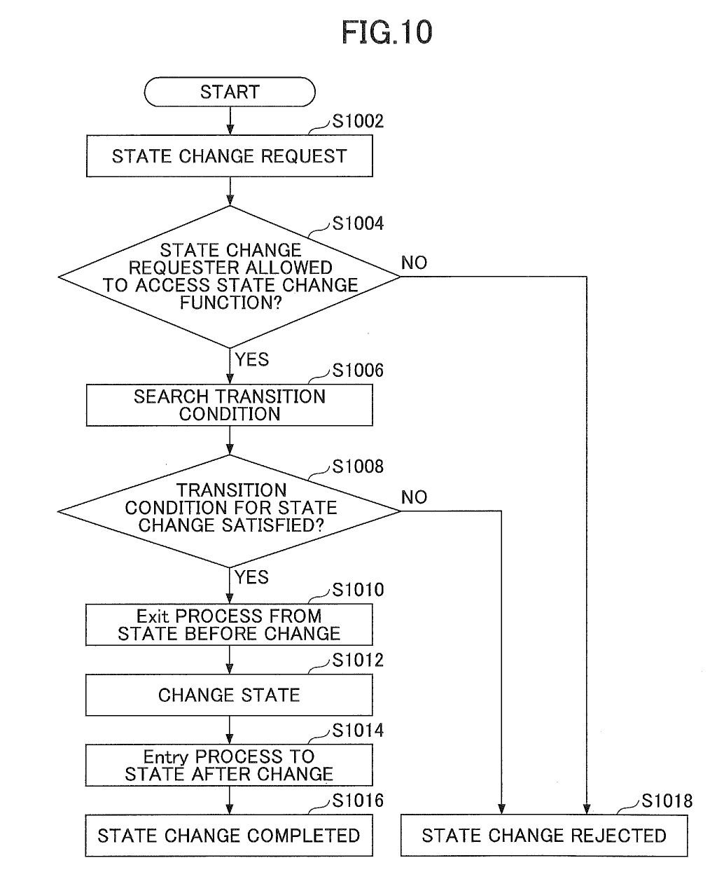

FIG. 12 illustrates a configuration example of the position management device 111. The position management device 111 includes a position authentication unit 1111, a position registration information storage unit 1112, and a position information acquiring unit 1113.

The position authentication unit 1111 refers to the position information of the next stage stored in the position registration information storage unit 1112, compares the stored information with the position information of the present position acquired by the position information acquiring unit 1113, and sends the comparison result to the authentication device 110. The authentication device 110 sends information having attached a signature, to the authentication station 600, to authenticate that the position management device 111 is genuine. The authentication station 600 performs signature verification, and confirms whether the position management device 111 has not been replaced. A separate means for performing these authentication processes may be provided.

The position registration information storage unit 1112 manages the position registration information of at least the next stage. By managing only the position registration information of the next stage, the position registration information storage unit 1112 cannot manage all information in the operation plan information, such that the memory can be reduced, and impersonation by wrongfully using the position information can be prevented. In the process example described below, it is assumed that only the position registration information of the next stage is managed.

The position information acquiring unit 1113 acquires the position information of the present position by using a general-purpose technology such as GPS (Global Positioning System). Furthermore, in order to identify the position information of the present position, information of the base station of a mobile phone or a PHS or a Wi-Fi access point may be used to acquire the present position information, other than GPS.

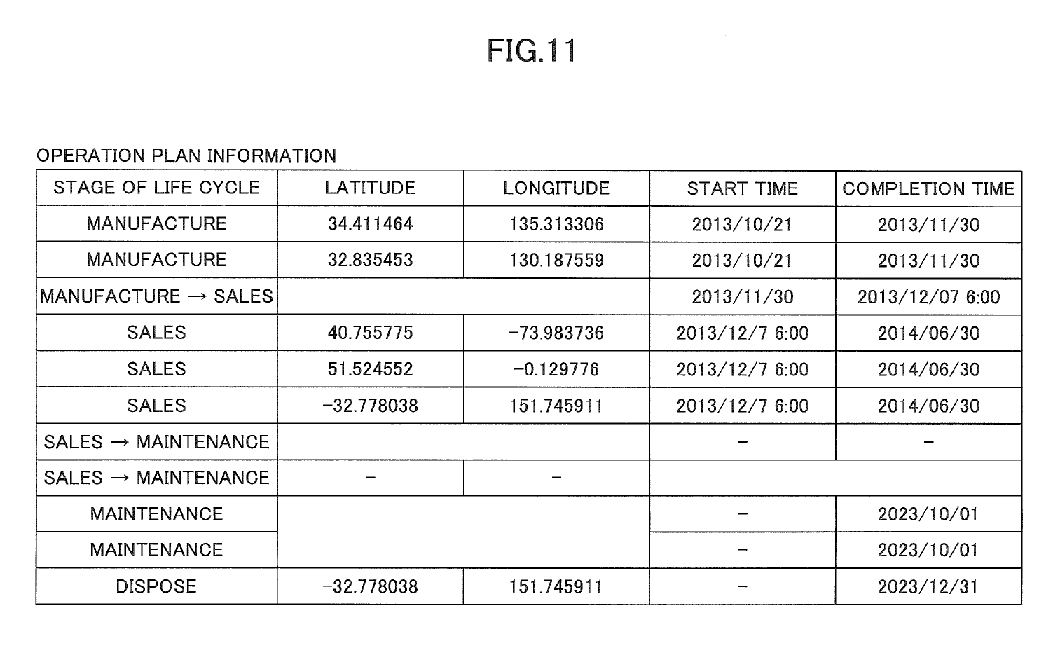

FIG. 13 illustrates an example of position registration information held by the position registration information storage unit 1112 of the position management device 111. FIG. 13 illustrates a state where the position registration information storage unit 1112 is holding position registration information constituted by the latitude and the longitude of the next stage “sales” acquired from the authentication station 600. Note that not all of the latitude and longitude information corresponding to the next stage needs to be held; a part of the latitude and longitude information may be acquired and held as position registration information according to an arrangement of the authentication station 600.

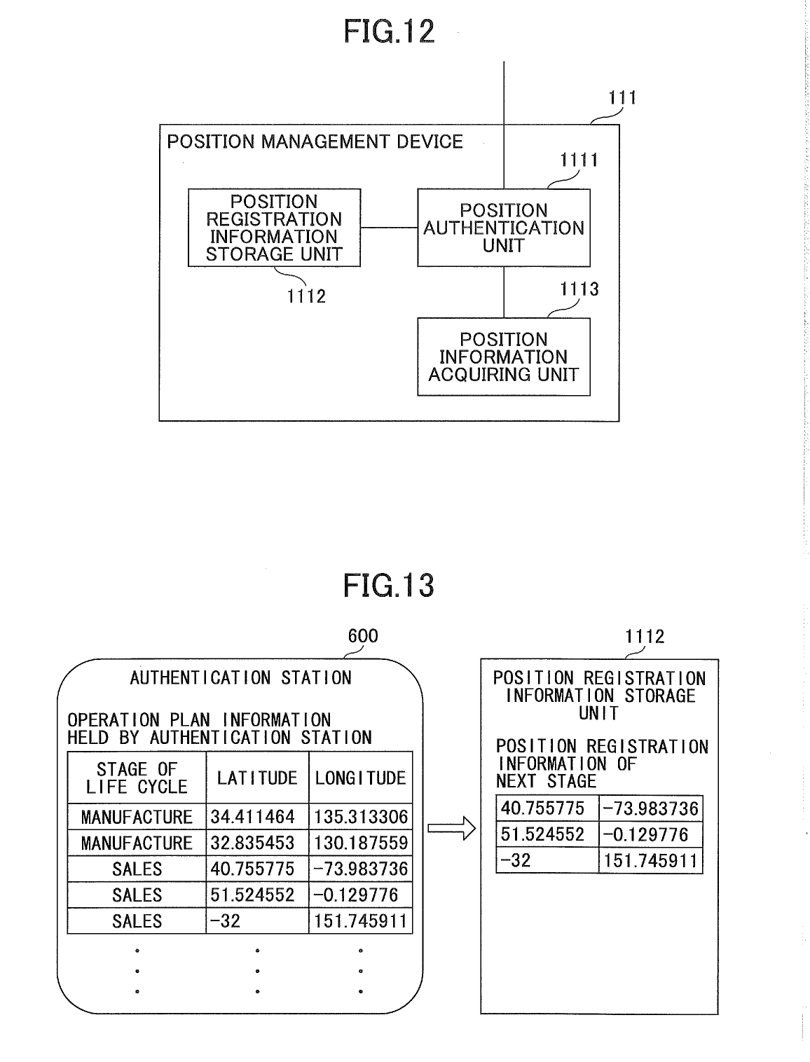

FIG. 14 illustrates a configuration example of the time management device 112. The time management device 112 includes a time authentication unit 1121 and a calendar information storage unit 1122.

The time authentication unit 1121 refers to the calendar information of the next stage stored in the calendar information storage unit 1122, compares the stored information with the present time information acquired from the authentication device 110, and sends the comparison result to the authentication device 110. The authentication device 110 sends information having attached a signature, to the authentication station 600, to authenticate that the time management device 112 is genuine. The authentication station 600 performs signature verification, and confirms whether the time management device 112 has not been replaced. A separate means for performing these authentication processes may be provided.

The calendar information storage unit 1122 manages the calendar information of at least the next stage. By managing only the calendar information of the next stage, the calendar information storage unit 1122 cannot manage all information in the operation plan information, such that the memory can be reduced and impersonation by wrongfully using the calendar information can be prevented. In the process example described below, it is assumed that only the calendar information of the next stage is managed.

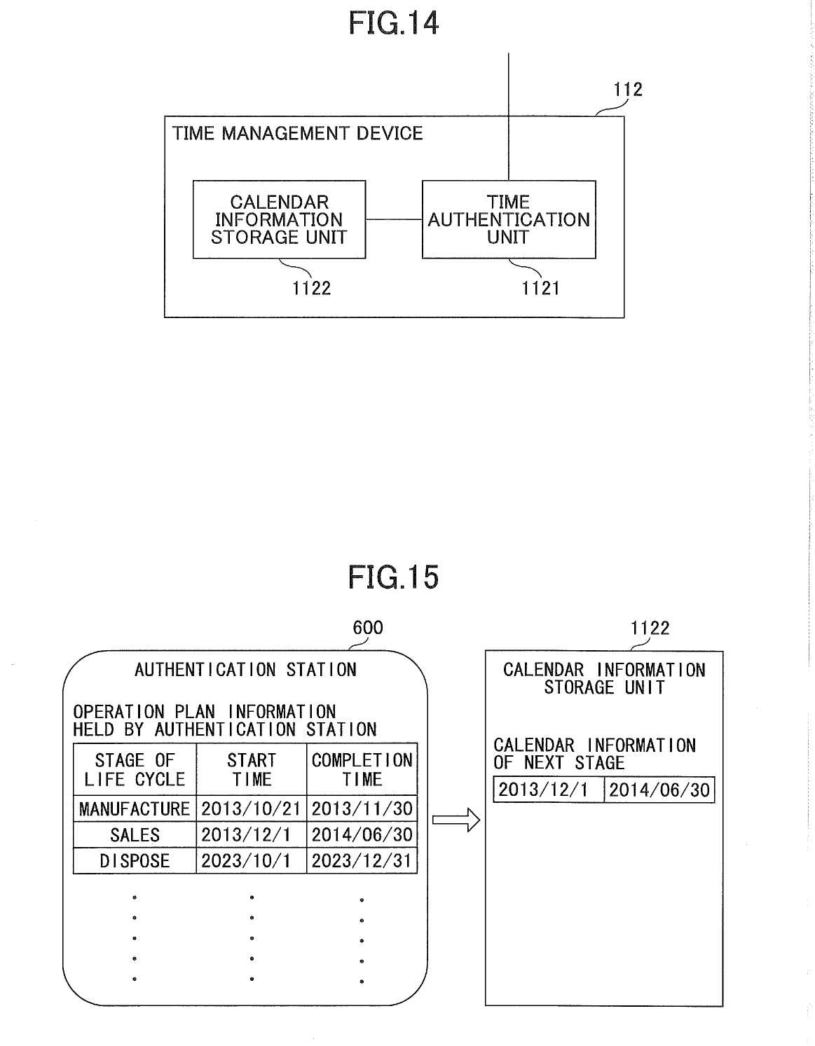

FIG. 15 illustrates an example of calendar information held by the calendar information storage unit 1122 of the time management device 112. FIG. 15 illustrates a state where the calendar information storage unit 1122 is holding calendar information constituted by the start time and the completion time of the next stage “sales” acquired from the authentication station 600.

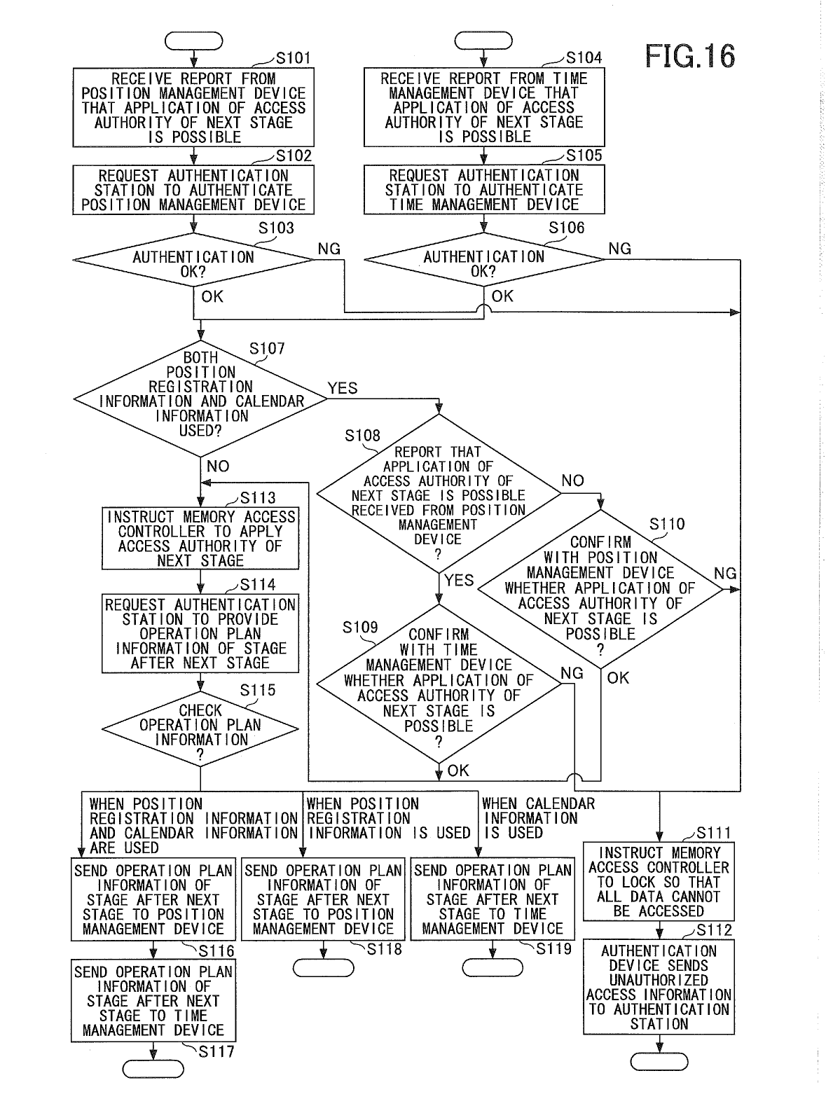

FIG. 16 is a flowchart of a process example of regular control by the authentication device 110 using the operation plan information. Note that it is assumed that, in the manufacture stage, position registration information and calendar information are set as initial values in the position management device 111 and the time management device 112, respectively.

In steps S101 and S104 of FIG. 16, the authentication device 110 is in a state of being prepared to receive a report that application of the access authority of the next stage is applicable, from the position management device 111 and the time management device 112, respectively, at a stationary time.

Then, when a report is received, in steps S102 and S105, the authentication device 110 requests the authentication station 600 to perform authentication, in order to determine whether the respective devices have not been replaced with fake devices.

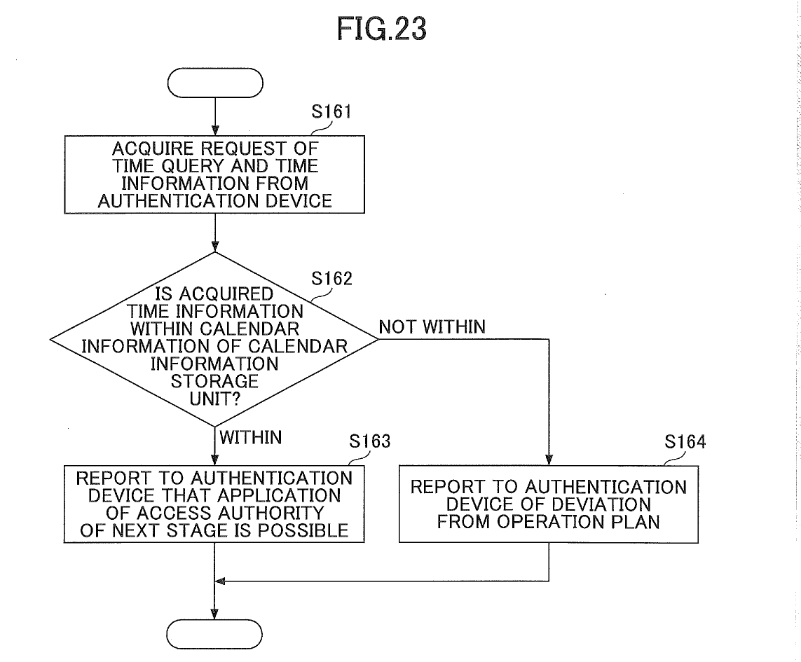

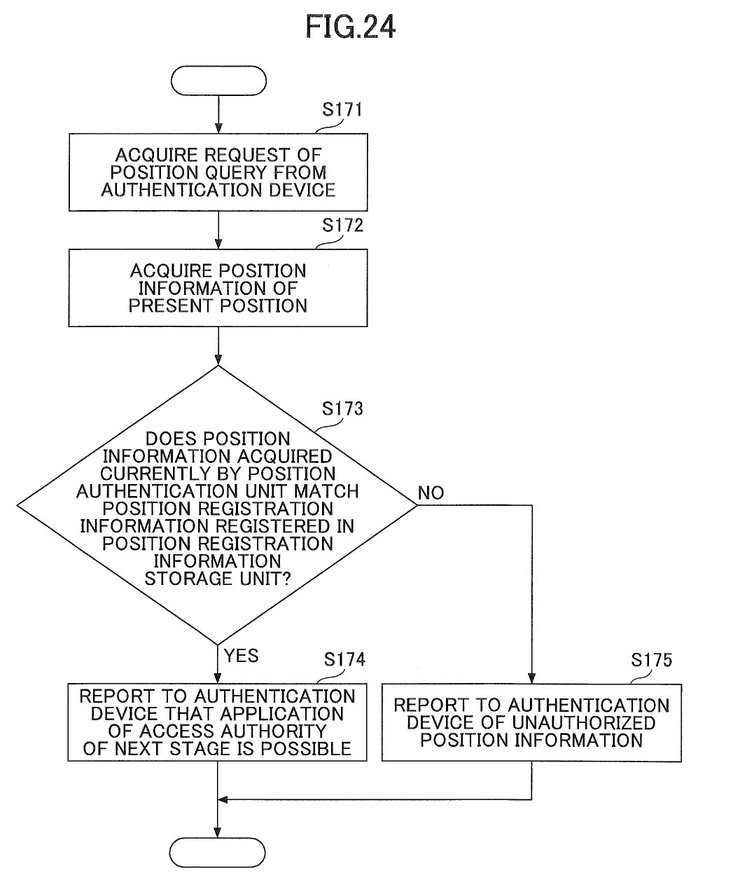

In steps S103 and S106, when the authentication of either one is OK, in step S107, the authentication device 110 determines whether both the position registration information and the calendar information are used, based on the operation plan information. When both are used, in steps S108 through S110, the authentication device 110 confirms whether it is possible to apply the access authority of the next stage, with respect to a device that has not received a report. Note that details of step S109 are described with reference to FIG. 23, and details of step S110 are described with reference to FIG. 24.

When the authentication or the confirmation is NG in the processes described above, it is determined that there is unauthorized access, and in step S111, the authentication device 110 instructs the memory access controller 107 to lock such that all of the data cannot be accessed, and in step S112, the authentication device 110 sends information indicating the unauthorized access to the authentication station 600.

In cases other than cases where the authentication or the confirmation is NG, in step S113, the authentication device 110 instructs the memory access controller 107 to apply the access authority of the next stage.

Subsequently, in order to manage the stage after the next stage, in step S114, the authentication device 110 requests the authentication station 600 to provide the operation plan information of the stage after the next stage, and acquires the information. Then, in step S115, the authentication device 110 determines whether only the position registration information is to be handled, or only the calendar information is to be handled, or both are to be handled, based on the operation plan information, and according to the determination, in steps S116 through S119, the authentication device 110 sends necessary information to the devices.

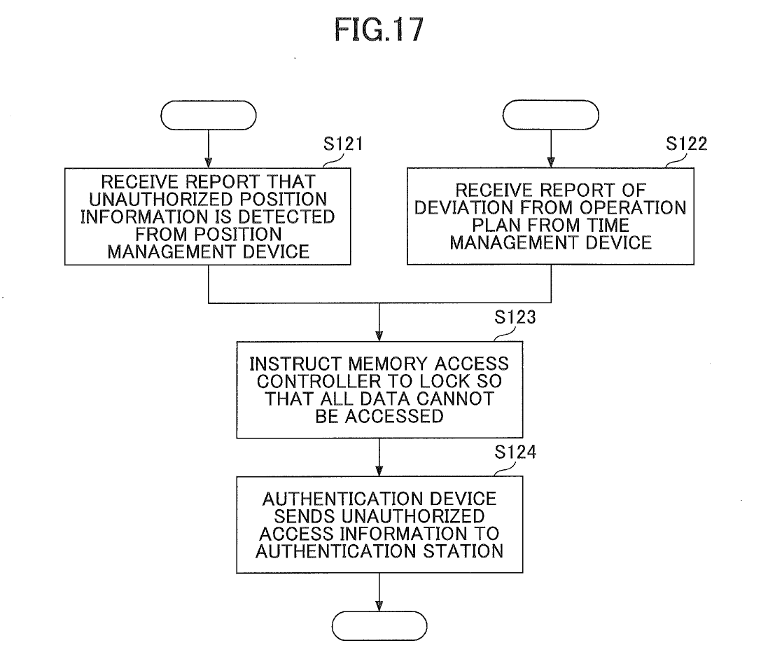

FIG. 17 is a flowchart of a process example of a case where the authentication device 110 receives unauthorized access information from the position management device 111 or the time management device 112.

In step S121 or step S122 of FIG. 17, when a report that an abnormality has been detected is received from the position management device 111 or the time management device 112, the authentication device 110 performs the following process. That is, in order to prevent unauthorized access to the data managed by the life cycle state management module 100, in step S123, the authentication device 110 instructs the memory access controller 107 to lock such that all of the data cannot be accessed. Subsequently, in step S124, the authentication device 110 sends unauthorized access information to the authentication station 600.

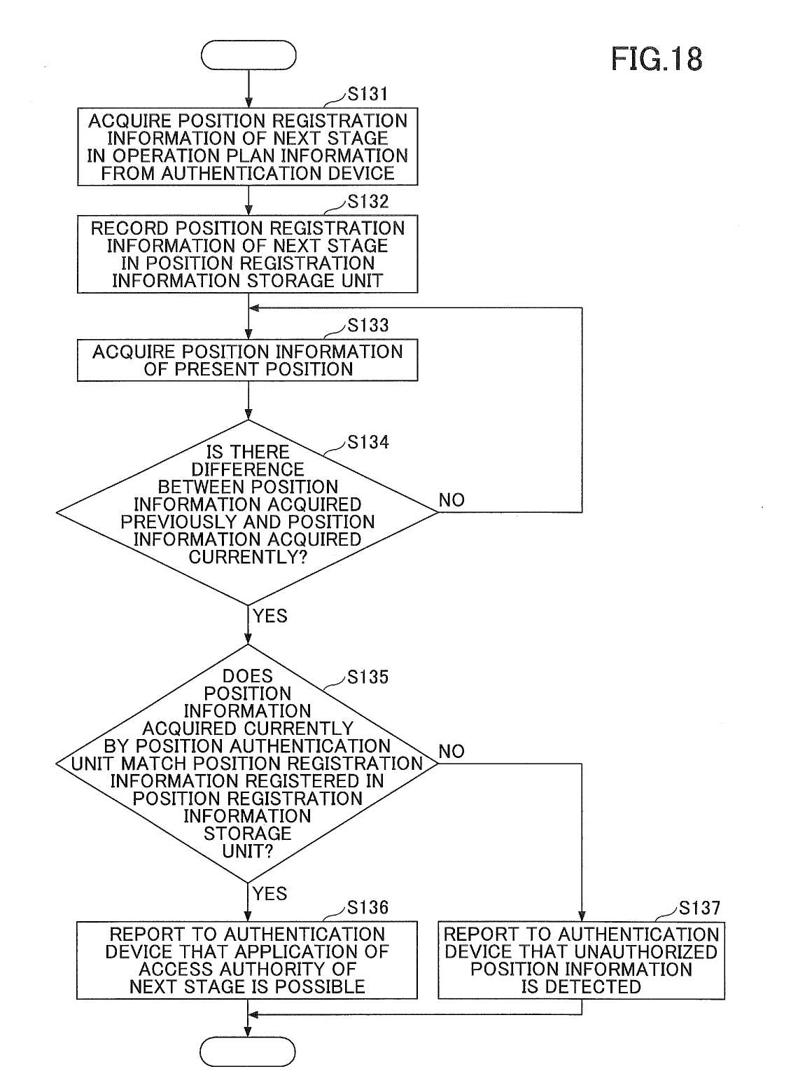

FIG. 18 is a flowchart of a process example of regular control by the position management device 111.

In FIG. 18, in step S131, the position management device 111 acquires the position registration information of the next stage in the operation plan information from the authentication device 110, and in step S132, the position management device 111 records the acquired position registration information in the position registration information storage unit 1112.

Next, in step S133, the position management device 111 acquires the position information of the present position by the position information acquiring unit 1113, and in step S134, the position management device 111 determines whether there is a difference between the position information acquired previously and the position information acquired currently, and when there is no difference, the process returns to step S133. Note that the determination as to whether there is a difference can have an allowable range (a range of difference that can be determined as being the same).

When it is determined that there is a difference between the position information acquired previously and the position information acquired currently, in step S135, the position management device 111 determines whether the position information acquired currently matches the position registration information registered in the position registration information storage unit 1112, by the position authentication unit 1111.

Then, when the above information items match, in step S136, the position management device 111 reports to the authentication device 110 that application of the access authority of the next stage is possible. When the above information items do not match, in step S137, the position management device 111 reports to the authentication device 110 that unauthorized position information is detected.

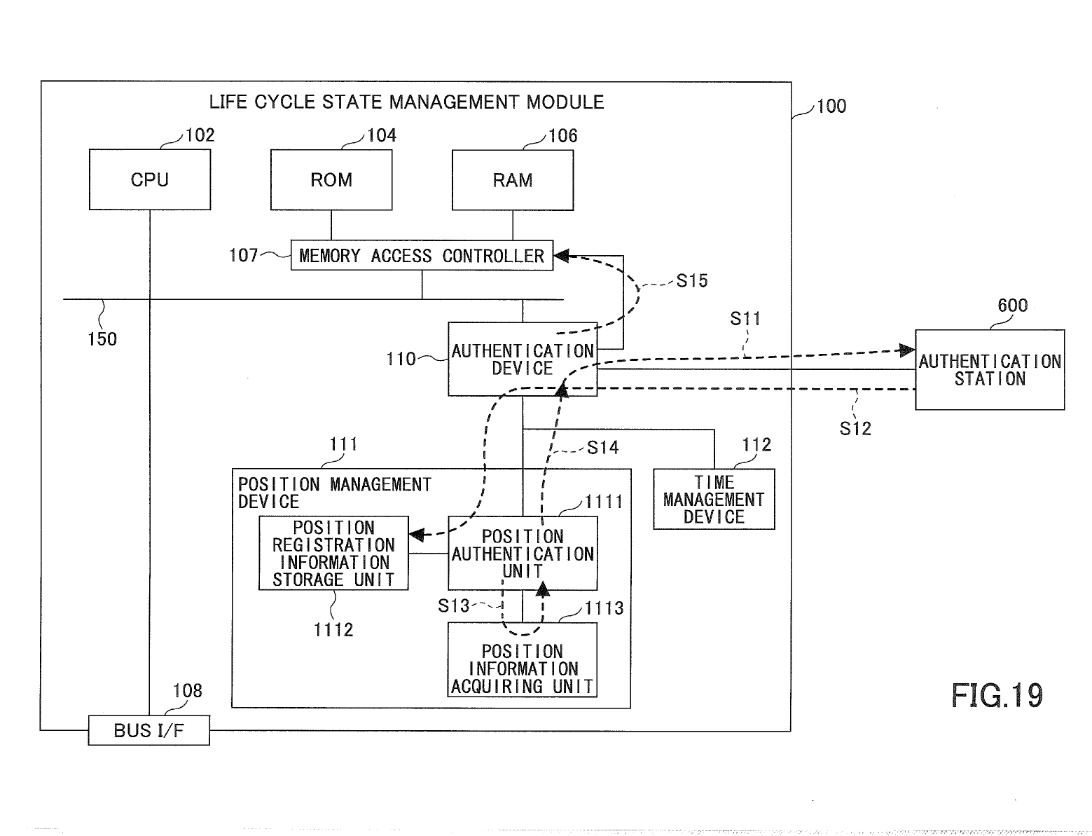

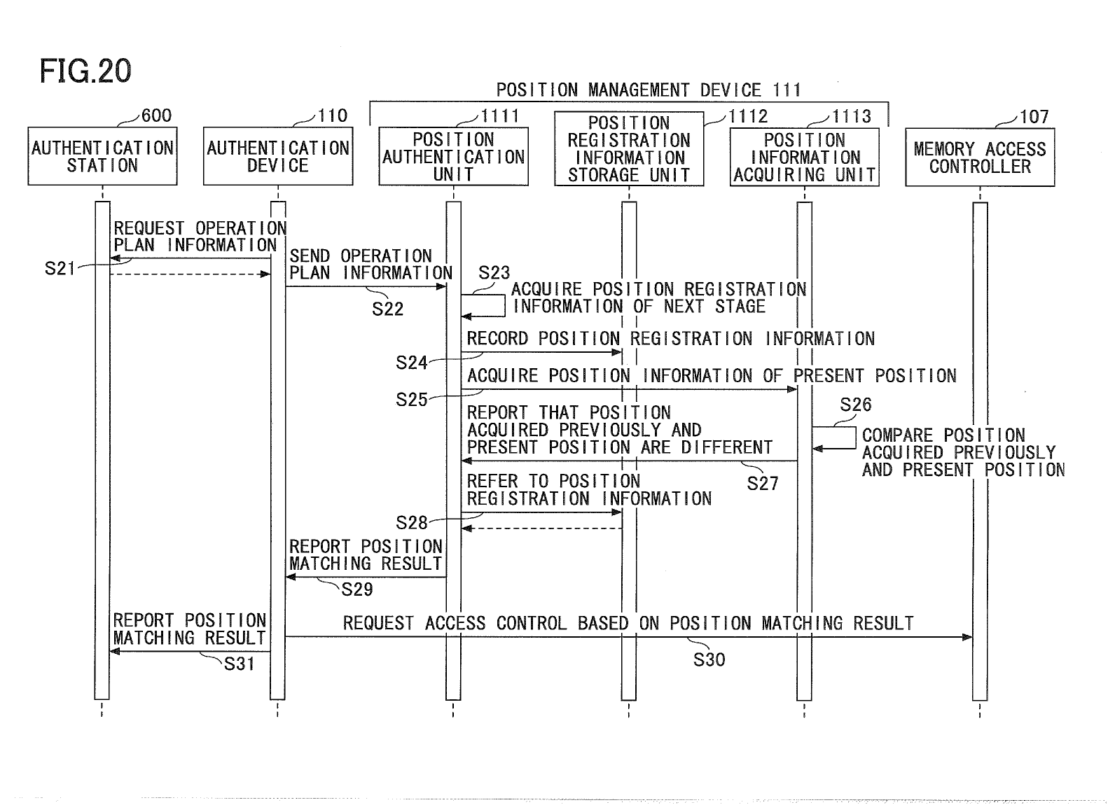

FIG. 19 illustrates an example of communication with surrounding elements performed in regular control by the position management device 111, and FIG. 20 is a corresponding sequence diagram.

In FIGS. 19 and 20, the authentication device 110 requests the authentication station 600 to provide operation plan information (steps S11, S21).

The position management device 111 acquires the operation plan information from the authentication station 600 via the authentication device 110, and registers the position registration information in the position registration information storage unit 1112 (steps S12, S22 through S24).

The position authentication unit 1111 detects, by the position information acquiring unit 1113, the position information of the present position that is different from the previous position information (steps S13, S25 through S27).

The position authentication unit 1111 performs authentication based on the position registration information, and reports the authentication result to the authentication device 110 (steps S14, S28 through S29).

The authentication device 110 controls the memory access controller 107 in accordance with the authentication result (steps S15, 30).

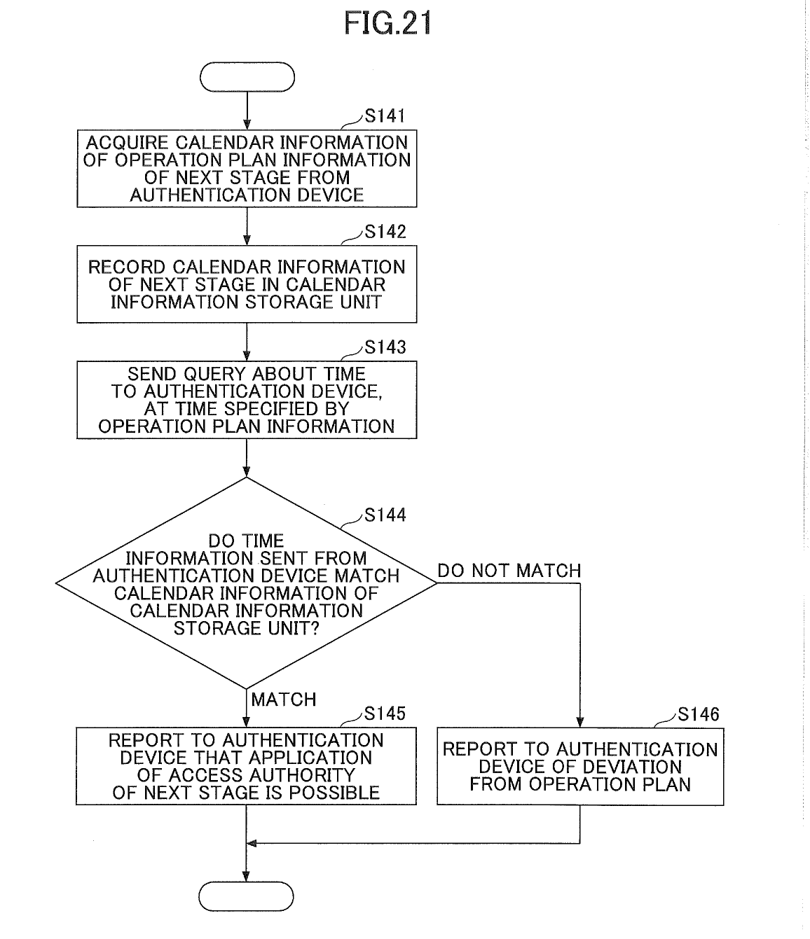

FIG. 21 is a flowchart of a process example of regular control by the time management device 112.

In FIG. 21, in step S141, the time management device 112 acquires the calendar information of the next stage in the operation plan information from the authentication device 110, and in step S142, the time management device 112 records the acquired calendar information in the calendar information storage unit 1122.

Next, in step S143, when the time specified by the operation plan information approaches (start time and completion time in calendar information), the time management device 112 queries the authentication device 110 of the time. The time management device 112 queries the authentication device 110 of the time, because the time at the time management device 112 may have been tampered. With respect to the time information acquired via the authentication device 110, the time error between that of the authentication station 600 is assumed to be assured by NTP (Network Time Protocol), RTP (Real-time Transport Protocol), etc.

Next, in step S144, the time management device 112 determines, by the time authentication unit 1121, whether the time information sent from the authentication device 110 matches the calendar information of the calendar information storage unit 1122. This process is to determine whether the time at the time management device 112 is accurate.

When it is determined that the above information items match, in step S145, the time management device 112 reports to the authentication device 110 that application of the access authority of the next stage is possible. When the above information items do not match, in step S146, the time management device 112 reports to the authentication device 110 that the operation plan is deviated.

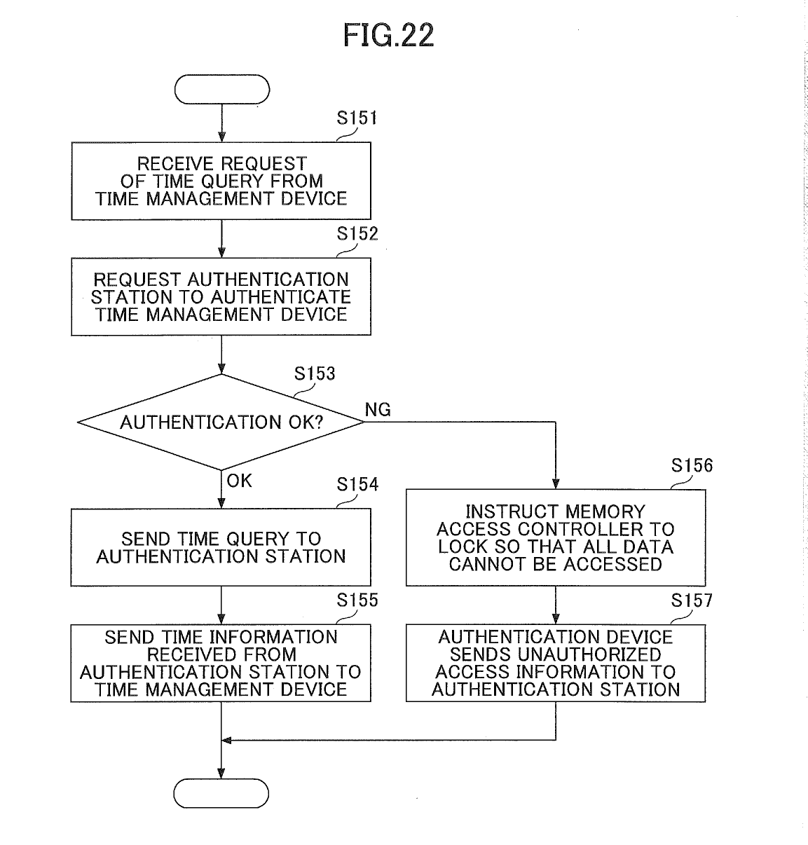

FIG. 22 is a flowchart of a process example of a case where the authentication device 110 receives a query about the time from the time management device 112.

In FIG. 22, in step S151, the authentication device 110 receives a request to query the time from the time management device 112, in step S152, the authentication device 110 requests the authentication station 600 to authenticate the time management device 112.

In step S153, when the authentication is OK, in step S154, the authentication device 110 queries the authentication station 600 of the time, and in step S155, the authentication device 110 sends the time information received from the authentication station 600 (time information issued by authentication station 600) to the time management device 112.

When the authentication is NG, in step S156, the authentication device 110 instructs the memory access controller 107 to lock such that all of the data cannot be accessed, and in step S157, the authentication device 110 sends unauthorized access information to the authentication station 600.

FIG. 23 is a flowchart of a process example of a case where the time management device 112 receives a query from the authentication device 110. That is, this is a process that is performed when the transition of the next stage is being managed based on the position registration information and the calendar information, and the position has been authenticated first, and the authentication device 110 makes a query to the time management device 112 as to whether the time management is being correctly performed.

In FIG. 23, in step S161, the time management device 112 acquires a request to query the time and time information from the authentication device 110, and in step S162, the time management device 112 determines whether the acquired time information is within the calendar information of the calendar information storage unit 1122. There is a possibility that the time information implements stage transition before the completion time in the calendar information, and therefore it is confirmed whether the present time is within the completion time.

Then, when the time information is within the calendar information, in step S163, the time management device 112 reports to the authentication device 110 that application of the access authority of the next stage is possible.

When the time information is not within the calendar information, including a case of a clearly strange time that does not match the calendar information, in step S164, the time management device 112 reports to the authentication device 110 that the operation plan is deviated.

FIG. 24 is a flowchart of a process example of case where the position management device 111 receives a query from the authentication device 110. That is, when the transition to the next stage is managed based on the position registration information and the calendar information, and the time is authenticated first, a query is made from the authentication device 110 to the position management device 111 as to whether the position management is correctly performed.

In FIG. 24, in step S171, the position management device 111 acquires a request to query the position from the authentication device 110, and in step S172, the authentication device 110 acquires the position information of the present position by the position information acquiring unit 1113.

Then, in step S173, the position management device 111 determines whether the position information currently acquired matches the position registration information registered in the position registration information storage unit 1112, by the position authentication unit 1111.

Then, when the above information items match, in step S174, the position management device 111 reports to the authentication device 110 that application of the access authority of the next stage is possible.

When the above information items do not match, in step S175, the position management device 111 reports to the authentication device 110 of the unauthorized position information.

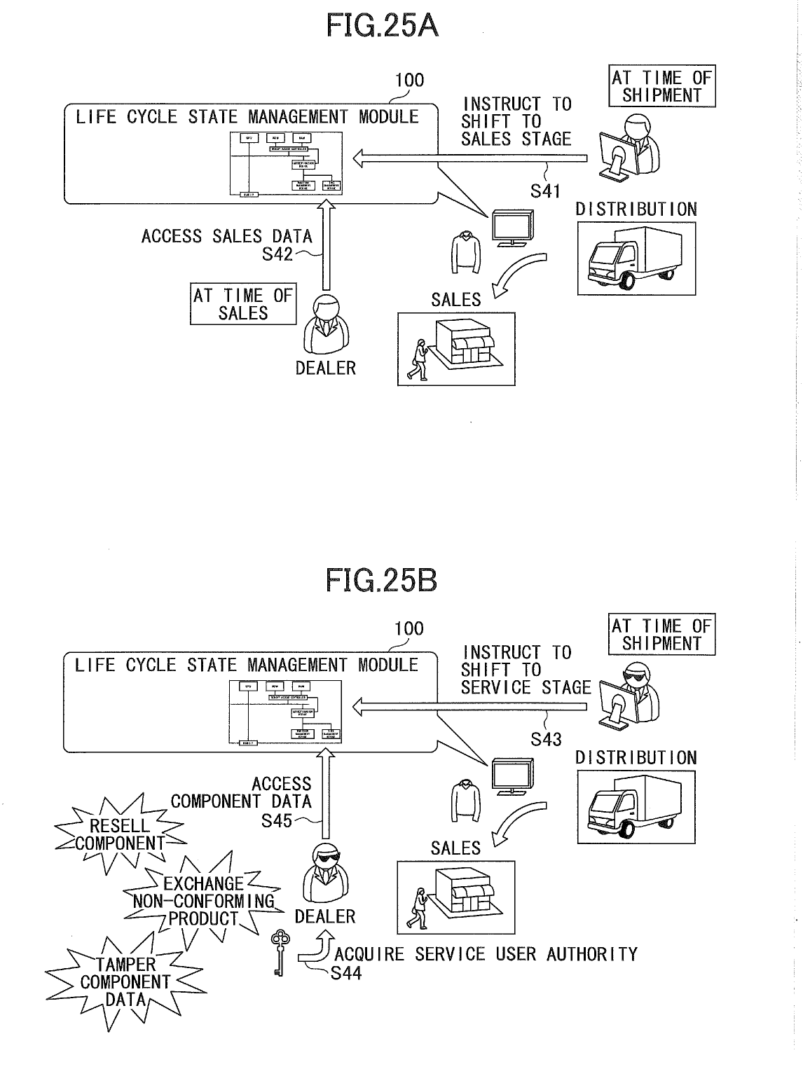

FIGS. 25A and 25B illustrate specific examples of cases where control is not implemented based on the operation plan information; FIG. 25A illustrates a process under normal circumstances, and FIG. 25B illustrates a process when an attempt for unauthorized access is made.

In FIG. 25A, after the person in charge of distribution completes the procedure of user authentication at the time of shipment, in step S41, a “sales stage shift instruction” is given to the life cycle state management module 100, and the stage of the life cycle in the life cycle state management module 100 transits from “manufacture” to “sales”. The dealer who has received the product in which the life cycle state management module 100 is installed, can perform “sales data access” based on the access authority of the dealer in step S42.

In this case, for example, when the distribution person and the dealer devise a scheme, as illustrated in FIG. 25B, in step S43, the distribution person makes a “service stage shift instruction” that is different from regular procedures, the dealer obtains the access authority of the server user, and in step S44, the dealer is able to make “component data access” in step S44.

Accordingly, an access authority is given to a user who is not supposed to be given an access authority, which makes it possible to resell components, exchange non-conforming products, and tamper component data. This problem occurs because the access authority is controlled by the intervention of a person, and therefore, in order to resolve this problem, it is effective to implement control based on the operation plan information.

Note that in the above process, it is assumed that when the authentication device 110 performs processes with the position management device 111 or the time management device 112, authentication is performed by the authentication station 600; however, a timer may be provided in the authentication device 110, and authentication by the authentication station 600 may be omitted for a predetermined time period from when the authentication device 110 starts operating (authentication valid period). That is, when performing processes with the position management device 111 or the time management device 112, the time is compared with a threshold of the timer determined in advance, and when the threshold is not exceeded, access by the position management device 111 or the time management device 112 may be possible, and when the threshold is exceeded, the authentication station 600 is to perform the authentication.

Furthermore, the access control unit 162 may be provided with a function such that only a user having special authority is able to access the data that has been locked by the memory access controller 107 upon detecting an unauthorized access. Accordingly, the data that is to be rescued can be safely extracted.

Furthermore, by inputting the life cycle state managed by the device in the authentication station 600, the authentication station 600 can automatically extract the state between stages of the life cycle, and the user can register the position registration information and the calendar information. Accordingly, the efficiency in creating the operation plan information can be increased.

Furthermore, by providing the authentication station 600 with a function to log the unauthorized access information sent from the authentication device 110, it is possible to track unauthorized accesses.

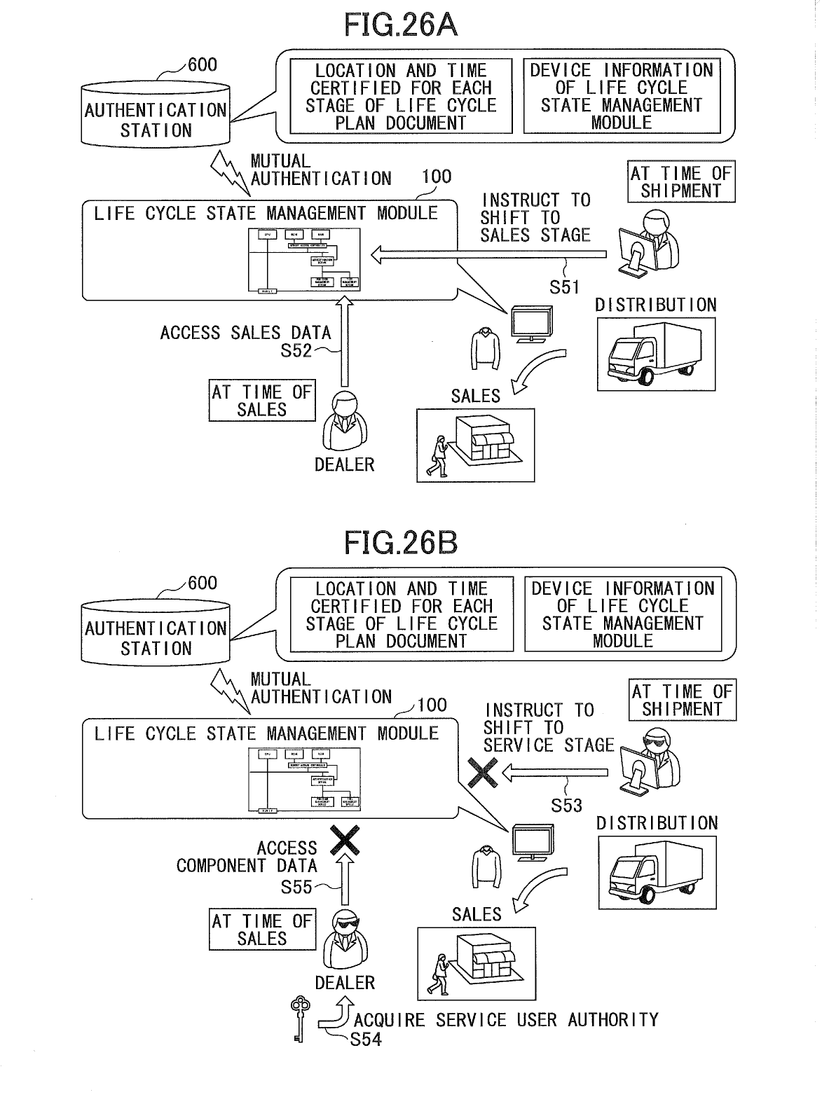

FIGS. 26A and 26B illustrate specific examples of cases where control is implemented based on the operation plan information; FIG. 26A illustrates a process under normal circumstances, and FIG. 26B illustrates a process when an attempt for unauthorized access is made.

In FIGS. 26A and 26B, in the authentication station 600, there are a “life cycle plan document (operation plan information)” storing the location and the time certified for each stage, and “device information of life cycle state management module” for proving that the position management device 111 and the time management device 112 are genuine. The life cycle state management module 100 performs mutual authentication by these information items, thus realizing stage transition of the life cycle without the intervention of a person.

In FIG. 26A, after the person in charge of distribution completes the procedure of user authentication, in step S51, a “sales stage shift instruction” is given to the life cycle state management module 100, and the stage of the life cycle in the life cycle state management module 100 transits from “manufacture” to “sales” on condition that the transition conforms with the operation plan information. Accordingly, the dealer who has received the product in which the life cycle state management module 100 is installed, can perform “sales data access” based on the access authority of the dealer in step S52.

In FIG. 26B, for example, when the distribution person and the dealer devise a scheme, and the distribution person intentionally attempts to instruct the transition of the stage of the life cycle in step S53, the position and time do not conform with the operation plan information, and therefore the stage transition of the life cycle cannot be performed. Therefore, in step S54, access to the component data cannot be performed.

### <Overview>

As described above, according to the present embodiment, impersonation can be prevented when transiting to the next stage in the life cycle.

According to an aspect of the present invention, there is provided a control method executed by a computer that constitutes a management module installed in a device holding control target data inside the device, the control method including managing a life cycle state that the device is presently in; receiving authentication data, authenticating a user, and giving a response indicating a role of the user; acquiring a present life cycle state managed at the managing when an access request to access the control target data is received; authenticating the user and acquiring the role of the authenticated user; acquiring access possibility information based on the present life cycle state and the role of the user who has made the access request, the access possibility information being acquired from a state access control policy associated with the control target data; controlling access to the control target data based on the access possibility information; and performing a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

According to one embodiment of the present invention, a device and a management module are provided, which are capable of preventing impersonation when transiting to the next stage of a life cycle.

The device and the management module are not limited to the specific embodiments described herein, and variations and modifications may be made without departing from the spirit and scope of the present invention. That is, the present invention is not to be construed as being limited by the detailed descriptions of the specific examples and accompanying drawings.

The state management unit 164 is an example of a state management unit. The user authentication unit 160 is an example of a user authentication unit. The access control unit 162 is an example of an access control unit. The authentication device 110 and the memory access controller 107 are an example of an access prohibiting unit.

The present application is based on and claims the benefit of priority of Japanese Priority Patent Application No. 2014-186453, filed on Sep. 12, 2014, the entire contents of which are hereby incorporated herein by reference.

What is claimed is:

1. A device holding control target data inside the device, the device comprising:
a state management unit configured to manage a life cycle state that the device is presently in;
a user authentication unit configured to receive authentication data, authenticate a user, and give a response indicating a role of the user;
an access control unit configured to
acquire a present life cycle state from the state management unit when an access request to access the control target data is received,
authenticate the user by the user authentication unit and acquire the role of the authenticated user,
acquire access possibility information based on the present life cycle state and the role of the user who has made the access request, the access possibility information being acquired from a state access control policy associated with the control target data, and
control access to the control target data based on the access possibility information; and
an access prohibiting unit configured to perform a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

2. The device according to claim 1, wherein
the access prohibiting unit performs the process at at least one of a timing when position information of a present position has changed and a timing when a start time or a completion time set in the operation plan information has approached.

3. The device according to claim 1, further comprising:
a position authentication unit configured to authenticate a position set in the operation plan information; and
a time authentication unit configured to authenticate a time set in the operation plan information.

4. The device according to claim 3, wherein
the position authentication unit holds only a position corresponding to a next life cycle state to which the device is to transit, among the positions set in the operation plan information, and
the time authentication unit holds only a time corresponding to the next life cycle state to which the device is to transit, among the times set in the operation plan information.

5. The device according to claim 3, wherein
the access prohibiting unit performs authentication when using at least one of the position authentication unit and the time authentication unit, and when the authentication is unsuccessful, the access prohibiting unit prohibits access to the control target data.

6. The device according to claim 5, wherein
the access prohibiting unit includes a timer, wherein the access prohibiting unit does not authenticate at least one of the position authentication unit and the time authentication unit within a predetermined period from an operation start time.

7. The device according to claim 1, wherein
the access control unit allows a user having a special authority to access the control target data for which access has been prohibited by the access prohibiting unit.

8. A management module installed in a device holding control target data inside the device, the management module comprising:
a state management unit configured to manage a life cycle state that the device is presently in;
a user authentication unit configured to receive authentication data, authenticate a user, and give a response indicating a role of the user;
an access control unit configured to
acquire a present life cycle state from the state management unit when an access request to access the control target data is received,
authenticate the user by the user authentication unit and acquire the role of the authenticated user,
acquire access possibility information based on the present life cycle state and the role of the user who has made the access request, the access possibility information being acquired from a state access control policy associated with the control target data, and
control access to the control target data based on the access possibility information; and
an access prohibiting unit configured to perform a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.

9. A non-transitory computer-readable recording medium storing a program that causes a computer that constitutes a management module installed in a device holding control target data inside the device, to execute a process comprising:
managing a life cycle state that the device is presently in;
receiving authentication data, authenticating a user, and giving a response indicating a role of the user;
acquiring a present life cycle state managed at the managing when an access request to access the control target data is received;
authenticating the user and acquiring the role of the authenticated user;
acquiring access possibility information based on the present life cycle state and the role of the user who has made the access request, the access possibility information being acquired from a state access control policy associated with the control target data;
controlling access to the control target data based on the access possibility information; and
performing a process of comparing at least one of a position and a time allowed in operation plan information with at least one of a present position and a present time at a predetermined timing, and prohibiting access to the control target data when at least one of the position and the time allowed in the operation plan information does not match at least one of the present position and the present time, based on the operation plan information in which life cycle states are associated with at least one of positions and times that are allowed for state transitions of the life cycle states.
